(19) United States
(12) Patent Application Publication
(10) Pub. No.: US 2026/0220494 A1
(43) Pub. Date: Jul. 30, 2026

(54) Cognitive Layer Knowledge Graph System with Layer-Specific Language Model Extraction and Agentic Cross-Document Integration

(71) Applicant: Syed Shan-E-Haider Rizvi, Brooklyn, NY (US)

(72) Inventor: Syed Shan-E-Haider Rizvi, Brooklyn, NY (US)

(21) Appl. No.: 19/572,363

(22) Filed: Mar. 19, 2026

(51) Int. Cl. G06N 5/022

(52) U.S. Cl. CPC G06N 5/022

(57) ABSTRACT

A computer-implemented system and method for organizing, extracting, and integrating knowledge in a typed knowledge graph structured according to a cognitive layer architecture. The system organizes 55 node types into six cognitive layers (Reality, Epistemic, Intent, Action, Memory, Agent), each enforced by a discriminated union property type providing compile-time type safety. Every node carries node-level confidence and salience scores representing truth likelihood and contextual importance, enabling probabilistic knowledge representation. An extraction pipeline processes unstructured documents through cognitive-layer-specific language model prompts with confidence calibration scales, each prompt specifying a complete extraction schema for its respective cognitive layer. In a preferred embodiment, a Reality pass executes first to establish an entity backbone, with remaining passes running in parallel. An agentic cross-document integration system employs a discovery agent and a verification agent with programmatic confidence cap enforcement and dynamic confidence ceiling computation based on the evidence landscape.

### CROSS-REFERENCE TO RELATED APPLICATIONS

None. This application is the first filing related to the inventions described herein.

### FIELD OF THE INVENTION

The present invention relates generally to knowledge graph systems, and more particularly to systems and methods for organizing knowledge into cognitively-structured typed graphs, extracting structured knowledge from unstructured documents using language model processing with cognitive-layer-specific extraction prompts, and integrating knowledge across multiple documents using autonomous AI agents with formal verification scoring.

### BACKGROUND OF THE INVENTION

### Problems with Existing Knowledge Graph Systems

Knowledge graphs have become a fundamental technology for representing structured information about entities and their relationships. However, existing knowledge graph systems suffer from several significant limitations that impair their utility for comprehensive knowledge management.

Untyped or Weakly Typed Schemas. Conventional property graph databases such as those described in U.S. Patent Application Publication No. US20120158633A1 (Google Knowledge Graph) employ entity categories primarily for web search optimization but lack a rigorous type system that enforces structural constraints on node properties. In such systems, any key-value pair may be stored on any node, leading to inconsistent data representations, runtime type errors, and the inability to validate property completeness at compile time. This deficiency means that knowledge graphs in production systems often accumulate malformed or incomplete records that degrade query reliability over time.

Single-Pass Extraction Architectures. Existing systems for constructing knowledge graphs from unstructured text, including approaches described in U.S. Patent Application Publication No. US20250131289A1 (Microsoft, “GraphRAG”) and commercial tools such as Neo4j LLM Knowledge Graph Builder, typically employ a single extraction pass that attempts to identify all entity types and relationship types in a single invocation of a language model. This single-pass approach has several drawbacks: (a) it limits the total number of distinct types that can be extracted reliably because language model context windows impose practical limits on prompt complexity; (b) it prevents the use of specialized language models optimized for different types of analysis (e.g., fast models for entity recognition versus reasoning models for epistemic analysis); (c) it forces sequential processing even when different extraction tasks are logically independent, thereby increasing total extraction latency; and (d) it prevents later passes from leveraging the output of earlier passes as contextual information.

Absence of Epistemic Structure. Prior art knowledge graphs represent factual assertions as unstructured text properties or simple subject-predicate-object triples. They lack formal structures for representing the epistemic status of knowledge, including the distinction between claims, evidence, warrants, and arguments; the tracking of uncertainty, confidence calibration, and evidence grounding; formal argumentation structures such as the Toulmin model (claim, evidence, warrant, backing, qualifier, rebuttal); and scientific methodology structures such as hypotheses, experiments, methods, anomalies, and paradigms. As described in U.S. Pat. No. 11,204,960B2 (IBM), prior knowledge graph augmentation approaches focus on statistical and tabular data integration rather than epistemic reasoning structures. The GraphRAG system described in US20250131289A1 employs hierarchical community summarization but does not implement formal argumentation models or distinguish between different epistemic types of knowledge.

No Cross-Document Integration with Verification. Existing knowledge graph systems either require manual curation to identify cross-document relationships or employ simple similarity-based linking without formal verification. The KARMA system (multi-agent knowledge graph enrichment) uses nine collaborative agents for initial knowledge graph construction from a single source but does not address the problem of integrating and verifying connections across multiple previously ingested documents. No prior art describes a dual-agent architecture in which a discovery agent proposes cross-document connections and a separate verification agent independently scores proposals on multiple quality axes with programmatic confidence caps.

Lack of Cognitive Organization. Existing knowledge graph architectures organize nodes and edges by entity type or domain category but do not organize them according to cognitive function. Cognitive architectures such as SOAR and ACT-R model human cognition computationally but have not been applied to the organization of knowledge graph data. There is no prior system that partitions a knowledge graph into distinct cognitive layers (e.g., reality, epistemic, intent, action, memory, agent) where each layer serves a different cognitive function and each node type is deterministically assigned to exactly one layer.

Inefficient Entity Deduplication. During knowledge extraction from multi-chunk documents, the same entity may be referenced in many chunks. Existing systems either perform deduplication as a post-processing step (which requires re-scanning the entire graph) or perform per-chunk deduplication queries that do not share state across chunks (resulting in O(C*E) database queries where C is the number of chunks and E is the average number of entities per chunk). Prior approaches such as Graphiti use MinHash and Locality-Sensitive Hashing (LSH) for entity resolution but do not implement a cross-chunk in-memory cache that accumulates resolved entities throughout multi-chunk document processing, thereby reducing redundant database queries. Some prior art systems (such as Zep's Graphiti) employ LLM-based entity resolution within the deduplication loop, incurring per-entity language model invocation costs that scale linearly with entity count and produce non-deterministic resolution outcomes that vary across invocations.

### Summary of Technical Problems Addressed

The present invention addresses the foregoing limitations by providing: (1) a typed cognitive layer architecture for knowledge graphs with 55 distinct node types organized into six cognitive layers and enforced by discriminated union property structures; (2) a cognitive-layer-aware extraction pipeline that processes unstructured documents through language model prompts each specifying a complete extraction schema for a respective cognitive layer, with a preferred embodiment that sequences a Reality pass first to establish an entity backbone and then executes remaining cognitive layer passes in parallel; (3) a multi-tier batch entity deduplication system with a cross-chunk cache that reduces redundant database queries across chunks of the same document; and (4) an agentic cross-document integration system employing a discovery agent and a verification agent with five-axis scoring and programmatic confidence cap enforcement.

### SUMMARY OF THE INVENTION

In one aspect, the present invention provides a computer-implemented method for extracting structured knowledge from unstructured documents into a typed knowledge graph organized into a plurality of cognitive layers. The method comprises: receiving an unstructured document; segmenting the document into a plurality of text chunks; processing each text chunk through a language model configured with one or more cognitive-layer-specific extraction prompts, each prompt specifying a complete extraction schema for a respective cognitive layer including valid node types, valid edge types, type-specific property structures, and layer-specific extraction guidelines including confidence calibration scales and salience scoring guidance; constructing typed nodes with discriminated union property structures containing type-specific fields and with language-model-assigned confidence scores and salience scores stored as node-level metadata; resolving extracted nodes against existing graph content; storing the extracted nodes with typed properties, cognitive layer assignments, confidence scores, and salience scores in an embedded database; and creating provenance edges linking each extracted node back to its source chunk. In a preferred embodiment, the method executes a Reality pass first to establish an entity backbone and then runs remaining cognitive layer passes in parallel with entity context from the first pass, and resolves entities using a multi-tier batch deduplication system comprising a cross-chunk cache, batch exact alias resolution, batch node verification, and full-text search fallback.

In another aspect, the present invention provides a knowledge graph system comprising: a storage engine implementing an embedded Datalog database with tombstone sentinel soft-delete patterns, full-text search indices, and hierarchical navigable small world (HNSW) vector indices; a schema module defining a plurality of cognitive layers, a plurality of node types each deterministically mapped to one of the plurality of cognitive layers, and a discriminated union type for node properties providing compile-time type safety for each node type; a node data structure in which every node carries a confidence score field and a salience score field as node-level metadata stored alongside but outside of the discriminated union property field, enabling probabilistic knowledge representation where all knowledge has assessed truth likelihood and importance regardless of node type; a server module exposing a plurality of cognitive endpoints that map semantic operations to typed graph primitives using a deep-merge property override pattern; and an extraction pipeline module implementing multi-pass extraction with Reality-first sequencing and parallel subsequent passes.

In yet another aspect, the present invention provides a computer-implemented method for cross-document knowledge integration in a knowledge graph, comprising: selecting claims from the knowledge graph based on a priority ranking that prioritizes contradictions, weakly-evidenced claims, cross-document bridge candidates, and high-salience low-confidence claims; gathering context for each selected claim by retrieving source text via provenance edge traversal, fetching neighboring nodes with full typed properties, performing semantic similarity search, and performing web search; invoking a first AI agent (discovery agent) equipped with proposal tools for proposing new nodes, new edges, confidence updates, and entity merges; invoking a second AI agent (verification agent) that independently scores each proposal on five quality axes including evidence grounding, semantic plausibility, hallucination detection, confidence calibration, and structural safety; applying programmatic confidence caps based on evidence status; and routing proposals to auto-approved, needs-review, or rejected categories based on weighted verification scores.

These aspects of the invention provide specific technical improvements over prior art systems, including: improved extraction precision through cognitive-layer-specific prompts that provide complete per-layer schemas to the language model; reduced extraction latency through parallel multi-pass processing in preferred embodiments; reduced database queries through cross-chunk deduplication caching; improved type safety through discriminated union property enforcement at compile time; improved knowledge quality through dual-agent verification with programmatic confidence caps; improved knowledge organization through deterministic cognitive layer assignment; and probabilistic knowledge representation through node-level confidence and salience scores that enable evidence-driven knowledge prioritization, integration targeting, and temporal relevance decay.

### BRIEF DESCRIPTION OF THE DRAWINGS

The accompanying drawings, which are incorporated herein and constitute part of this specification, illustrate embodiments of the invention and, together with the description, serve to explain the principles of the invention.

FIG. 1 is a block diagram illustrating the overall system architecture of the cognitive layer knowledge graph system according to an embodiment of the present invention.

FIG. 2 is a diagram illustrating the six-layer cognitive architecture showing the mapping of node types to cognitive layers according to an embodiment of the present invention.

FIG. 3 is a diagram illustrating the discriminated union type hierarchy for node properties and edge properties according to an embodiment of the present invention.

FIG. 4 is a flowchart illustrating the multi-pass extraction pipeline showing Reality-first sequencing with parallel subsequent passes according to an embodiment of the present invention.

FIG. 5 is a flowchart illustrating the single-pass extraction process showing the collect-then-batch pattern for each cognitive layer according to an embodiment of the present invention.

FIG. 6 is a diagram illustrating the multi-tier batch entity deduplication pipeline showing the cascade from cross-chunk cache through full-text search fallback according to an embodiment of the present invention.

FIG. 7 is a block diagram illustrating the document ingestion and retrieval system showing chunk creation, extraction, embedding, and hybrid retrieval according to an embodiment of the present invention.

FIG. 8 is a diagram illustrating the cognitive endpoint request processing flow showing the merge_props deep-merge pattern according to an embodiment of the present invention.

FIG. 9 is a flowchart illustrating the agentic cross-document integration pipeline showing claim selection, discovery, verification, and human-in-the-loop approval according to an embodiment of the present invention.

FIG. 10 is a diagram illustrating the discovery agent architecture showing context assembly from provenance traversal, graph neighborhood, semantic search, and web search according to an embodiment of the present invention.

FIG. 11 is a diagram illustrating the five-axis verification scoring system with confidence cap enforcement according to an embodiment of the present invention.

FIG. 12 is a diagram illustrating the database schema showing the CozoDB Datalog relations, indices, and the tombstone sentinel pattern according to an embodiment of the present invention.

### DETAILED DESCRIPTION OF PREFERRED EMBODIMENTS

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to those skilled in the art, and the general principles defined herein may be applied to other embodiments and applications without departing from the scope of the invention. The present invention is not intended to be limited to the embodiments shown, but is to be accorded the widest scope consistent with the principles and features disclosed herein.

### I. System Architecture Overview

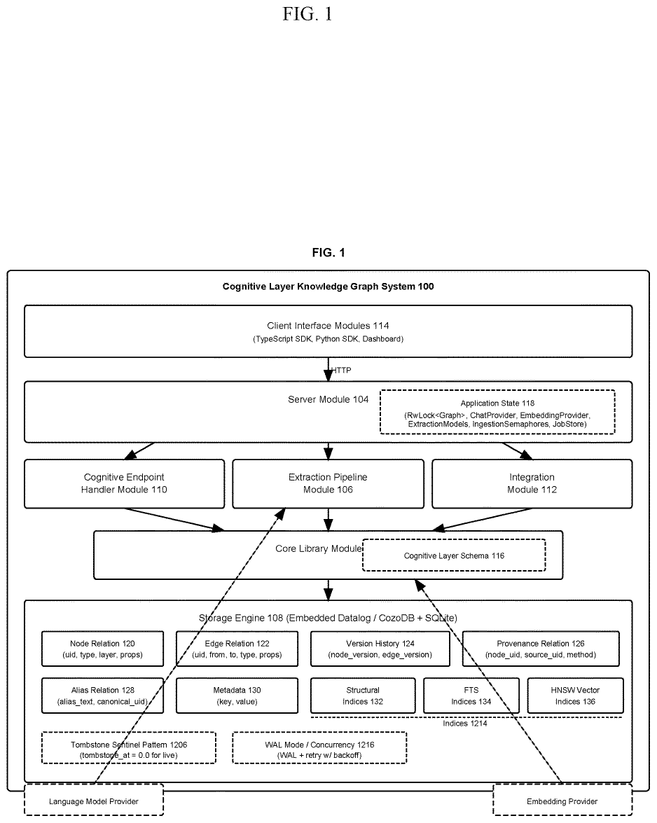

Referring now to FIG. 1, a block diagram illustrating the overall system architecture of the cognitive layer knowledge graph system 100 according to an embodiment of the present invention is shown. The system 100 comprises a core library module 102, a server module 104, an extraction pipeline module 106, a storage engine 108, a cognitive endpoint handler module 110, an integration module 112, and client interface modules 114.

The core library module 102 provides the fundamental data structures and operations for the knowledge graph, including node and edge creation, traversal, search, versioning, and lifecycle management. The core library module 102 defines the cognitive layer schema 116, which comprises six cognitive layers and 55 node types organized into a discriminated union type hierarchy, as described in detail below.

The server module 104 is an HTTP server built on an asynchronous web framework (in the preferred embodiment, the Axum framework for the Rust programming language). The server module 104 routes incoming HTTP requests to the cognitive endpoint handler module 110 and the extraction pipeline module 106. The server module 104 maintains application state 118 comprising a reference to the knowledge graph instance wrapped in a read-write lock for concurrent access, optional references to a language model chat provider and an embedding provider, extraction model configuration, ingestion semaphores for backpressure control, and an in-memory job store for tracking asynchronous processing tasks.

The storage engine 108 is an embedded Datalog database engine (in the preferred embodiment, CozoDB with a SQLite backend). The storage engine 108 stores the knowledge graph data in a plurality of relations including a node relation 120, an edge relation 122, node and edge version history relations 124, a provenance tracking relation 126, an entity alias relation 128, and a metadata relation 130. The storage engine 108 further maintains a plurality of indices including structural indices 132, full-text search (FTS) indices 134, and HNSW vector indices 136 for semantic similarity search.

The extraction pipeline module 106 implements the multi-pass cognitive layer extraction pipeline, which processes unstructured text documents through layer-specific language model invocations to produce typed knowledge graph nodes and edges, as described in detail in Section III below.

The cognitive endpoint handler module 110 implements 18 REST API endpoints that map semantic operations (e.g., “capture an observation,” “construct an argument,” “commit to a goal”) to typed graph primitives using the merge_props deep-merge pattern, as described in detail in Section IV below.

The integration module 112 implements the agentic cross-document integration system, which uses a discovery agent and a verification agent to identify and validate cross-document knowledge connections, as described in detail in Section V below.

The client interface modules 114 comprise client libraries (SDKs) for multiple programming languages (in the preferred embodiment, TypeScript and Python) and a web-based dashboard application providing visual interaction with the knowledge graph.

### II. Cognitive Layer Architecture and Typed Schema

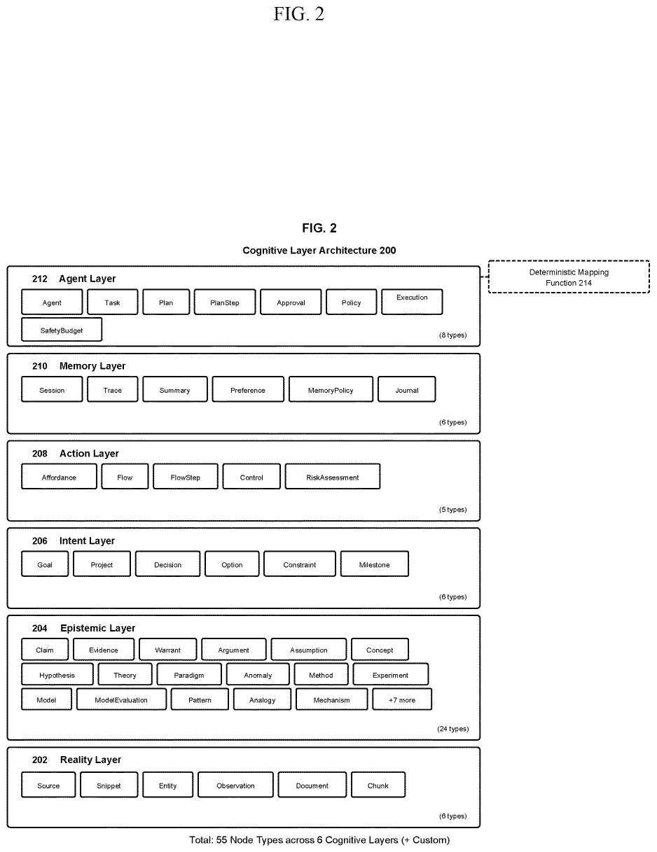

Referring now to FIG. 2, a diagram illustrating the six-layer cognitive architecture 200 according to an embodiment of the present invention is shown.

### II.A. The Six Cognitive Layers

The cognitive layer schema 116 organizes the knowledge graph into six cognitive layers 202, 204, 206, 208, 210, 212, each representing a distinct cognitive function. Each cognitive layer defines a disjoint set of node types. Every node type in the system is deterministically assigned to exactly one cognitive layer by a mapping function. The six cognitive layers are:

Reality Layer 202. The Reality layer 202 represents ground truth about the world. It contains node types for representing entities, observations, sources of information, and document structures. The Reality layer 202 comprises six node types: Source (information sources such as URLs, documents, or databases), Snippet (excerpted text from sources), Entity (named things including people, organizations, places, products, and technologies), Observation (factual observations including measurements, data points, and system events), Document (ingested documents), and Chunk (segments of documents produced during text chunking). Each Entity node carries typed properties including an entity_type field (constrained to values such as “person”, “organization”, “place”, “product”, “technology”, “event”, “concept”, or “other”), a canonical_name field, optional description, identifiers (a structured object for external identifiers such as URLs, DOIs, and ticker symbols), and attributes (a structured object for key-value metadata). Each Observation node carries typed properties including an observation_type field, a content field containing the observation text, and an optional timestamp.

Epistemic Layer 204. The Epistemic layer 204 represents knowledge about knowledge, implementing formal epistemological structures. It contains 24 node types organized into the following subcategories:

Core Reasoning: Claim (assertions that could be true or false, with properties including content, claim_type constrained to “factual”/“normative”/“predictive”/“definitional”/“causal”/“statistical”, certainty_degree, truth_status, scope, quantitative_value, unit, uncertainty_range, and event_date), Evidence (data or facts cited to support or refute claims, with properties including description, evidence_type constrained to “empirical”/“statistical”/“anecdotal”/“expert_testimony”/“documentary”/“experimental”, quantitative_value, unit, sample_size, statistical_significance, is_negative boolean, original_expectation, and source_url), Warrant (justificatory principles connecting evidence to claims, with properties including principle, warrant_type constrained to “deductive”/“inductive”/“abductive”/“probabilistic”/“causal”/“authority”, explicit_in_text boolean, strength, and domain_scope), Argument (complete argumentative structures with properties including summary, argument_type, strength, is_valid boolean, and is_sound boolean), and Assumption (stated or unstated premises with properties including content, assumption_type, explicit_in_text boolean, justification, and vulnerability).

Knowledge Structures: Concept (important terms or abstract ideas with properties including name, domain, definition, definition_type, abstraction_level, and alternative_definitions), Hypothesis (tentative explanations with properties including statement, hypothesis_type, status, testability_score, novelty, and predicted_observations as an array), Theory (comprehensive explanatory frameworks with properties including name, description, domain, status, explanatory_scope, core_commitments as an array, and predictive_successes as an array), Paradigm (overarching intellectual frameworks with properties including name, field, status, core_assumptions as an array, exemplar_problems as an array, accepted_methods as an array, and tension_score), and Anomaly (observations deviating from predictions with properties including description, anomaly_type, severity, persistence, and resolution_attempts).

Scientific Methodology: Method (investigation techniques with properties including name, description, method_type, domain, limitations as an array, validity_conditions as an array, and parameters as an array), and Experiment (specific empirical investigations with properties including description, name, design_type, variables_manipulated as an array, variables_measured as an array, controls as an array, sample_description, and date_conducted).

Formal Structures: Theorem (formally provable statements with properties including statement, name, proof_status, theorem_type, proof_technique, significance, and applications as an array), Equation (mathematical expressions with properties including expression, name, description, equation_type, variables as an array, parameters as an array, domain, and assumptions as an array), Model (simplified representations with properties including name, description, model_type, target_system, key_parameters as an array, simplifications as an array, and validation_status), and ModelEvaluation (model assessments with properties including evaluation_type, metrics as an array, failure_domains as an array, comparison_to as an array, and evaluation_date).

Patterns and Comparisons: Pattern (recurring regularities with properties including name, description, pattern_type, domains_observed as an array, instance_count, and generality), Analogy (cross-domain comparisons with properties including description, source_domain, target_domain, analogy_type, mapping_elements as an array, strength, and limitations as an array), and Mechanism (causal processes with properties including name, description, components as an array, interactions as an array, input, output, and level).

Reasoning Meta-Structures: InferenceChain (multi-step reasoning sequences with properties including description, chain_length, compound_confidence, propagation_method, weakest_link, and critical_assumptions as an array), SensitivityAnalysis (input sensitivity assessments with properties including analysis_type, target_claim_uid, sensitivity_map as an array, robustness_score, critical_inputs as an array, and break_points as an array), and ReasoningStrategy (named reasoning approaches with properties including name, description, strategy_type, applicable_contexts as an array, and limitations as an array).

Questions: Question (research questions with properties including text, question_type, scope, status, importance, tractability, and blocking_factors as an array), and OpenQuestion (unresolved questions with properties matching those of Question).

Intent Layer 206. The Intent layer 206 represents goals, decisions, and planning structures. It comprises six node types: Goal (objectives with properties including description, goal_type, status, priority, deadline, success_criteria as an array, and progress), Project (organized efforts with properties including name, description, status, started_at, and target_completion), Decision (choices with properties including question, status, decided_option_uid, decided_at, decision_rationale, and reversibility), Option (possible choices for a decision, with properties including description, pros as an array, cons as an array, estimated_effort, estimated_risk, and score), Constraint (limitations with properties including description, constraint_type, hard boolean, value, and unit), and Milestone (checkpoints with properties including description, status, target_date, reached_at, and criteria as an array).

Action Layer 208. The Action layer 208 represents capabilities and risks. It comprises five node types: Affordance (available actions with properties including action_name, description, affordance_type, source_uid, selector, parameters as an array, preconditions as an array, postconditions as an array, risk_level, and reversible boolean), Flow (process flows), FlowStep (individual steps in a flow), Control (control mechanisms), and RiskAssessment (identified risks with properties including target_uid, risk_type, severity, likelihood, mitigation, and requires_approval boolean).

Memory Layer 210. The Memory layer 210 represents experiential memory and distilled knowledge. It comprises six node types: Session (interaction sessions), Trace (detailed records of operations), Summary (distilled insights with properties including content, summary_type, compression_ratio, and generated_by), Preference (user preferences with properties including key, value, preference_type, learned boolean, explicit boolean, and evidence_count), MemoryPolicy (rules governing memory retention), and Journal (reflective entries).

Agent Layer 212. The Agent layer 212 represents agent operations in multi-agent systems. It comprises eight node types: Agent (AI agents with typed properties), Task (work items with properties including description, task_type, status, assigned_to, created_by, priority, deadline, parent_goal_uid, depends_on_task_uids as an array, and result_summary), Plan (structured plans with properties including description, status, step_count, estimated_risk, and proposed_at), PlanStep (individual plan steps), Approval (approval records), Policy (operational policies), Execution (execution records), and SafetyBudget (safety constraints for agent operations).

Additionally, the system supports a Custom node type and a Custom edge type that allow user-defined extensions while preserving the cognitive layer assignment mechanism.

### II.B. Deterministic Layer Mapping Function

A critical aspect of the cognitive layer architecture 200 is the deterministic mapping function 214 that maps every node type to exactly one cognitive layer. This mapping function 214 is implemented as a method on the NodeType enumeration type that uses pattern matching to return the appropriate Layer enumeration value. The mapping function 214 ensures that:
(a) Every node in the knowledge graph has an unambiguous cognitive layer assignment.
(b) The assignment is determined at compile time based on the node type, not at runtime based on user input.
(c) Queries and indices can be scoped to specific cognitive layers for efficient filtering.
(d) The cognitive layer of a Custom node type defaults to the Reality layer unless explicitly overridden in its property structure.

### II.C. Discriminated Union Property Type System

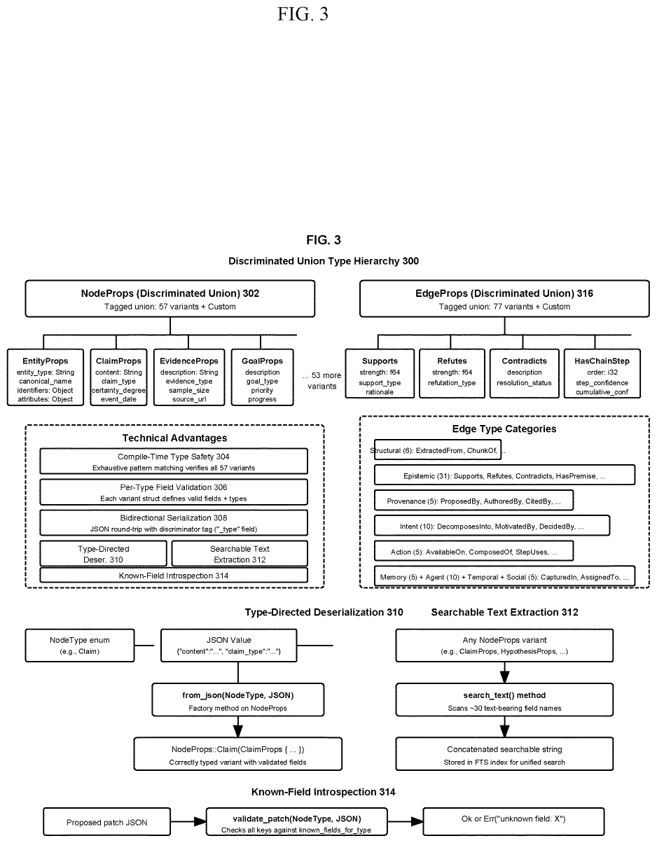

Referring now to FIG. 3, a diagram illustrating the discriminated union type hierarchy 300 according to an embodiment of the present invention is shown.

The discriminated union 302 for node properties (referred to as NodeProps in the preferred embodiment) is a tagged union type comprising one variant for each of the 55 node types plus a Custom variant. Each variant wraps a struct containing the type-specific fields for that node type. The union is tagged using a discriminator field (“_type”) that identifies which variant is active.

The discriminated union 302 provides the following technical advantages over prior art property-bag approaches:

Compile-time type safety 304. In the preferred embodiment (the Rust programming language), the compiler verifies at compile time that all code paths handle all 55 node type variants. Pattern matching on the discriminated union is exhaustive, meaning that any unhandled variant produces a compilation error. This eliminates an entire class of runtime errors present in schemaless property graph systems.

Per-type field validation 306. Each variant struct defines the specific fields applicable to that node type with their types, default values, and optionality. For example, the ClaimProps struct requires a content field of type String and optionally includes claim_type (constrained string), certainty_degree (floating-point number between 0 and 1), truth_status (constrained string), event_date (ISO 8601 date string), and other fields. Attempting to store a field not defined for a given node type produces a deserialization error, providing structural validation that is absent in schemaless property graphs.

Bidirectional serialization 308. The discriminated union 302 supports serialization to JSON (for storage in the Datalog database and for API responses) and deserialization from JSON (for API request processing and database retrieval). The serialization uses the discriminator field to tag the JSON representation, enabling unambiguous round-trip conversion. A separate method provides untagged serialization (omitting the discriminator field) for storage in the database props column where the node_type column already provides the discriminant.

Type-directed deserialization 310. A factory method (referred to as from_json in the preferred embodiment) accepts a NodeType value and a JSON value and produces the correctly typed NodeProps variant. This enables the storage layer to reconstruct strongly-typed property structures from the database without embedding type tags in every stored JSON document.

Searchable text extraction 312. The discriminated union 302 implements a method (referred to as search_text in the preferred embodiment) that extracts all user-authored text content from the properties of any node type. This method iterates over a curated list of text-bearing field names (including content, description, statement, name, principle, definition, and approximately 30 others) and concatenates their values into a single searchable string. This extracted text is stored in a denormalized search relation and indexed with full-text search, enabling unified text search across all 55 node types without requiring per-type search logic.

Known-field introspection 314. The discriminated union 302 implements a method (referred to as known_fields_for_type in the preferred embodiment) that returns the set of valid field names for any given node type by serializing a default instance to JSON and extracting the key set. This enables runtime validation of property patches: a patch validation method (referred to as validate_patch) verifies that all keys in a proposed property update are known fields for the target node type, rejecting unknown fields with specific error messages.

A corresponding discriminated union 316 for edge properties (referred to as EdgeProps in the preferred embodiment) provides the same type safety and validation mechanisms for the system's 77 named edge types plus a Custom variant. Representative edge property variants include: Supports (with optional strength and support_type fields), Refutes (with optional strength and refutation_type fields), Contradicts (with optional description, contradiction_type, resolution_status, and proposed_resolution fields), HasChainStep (with optional order, step_confidence, and cumulative_confidence fields), and PropagatesUncertaintyTo (with optional propagation_factor and propagation_type fields). The complete set of 31 epistemic edge types enables the representation of complex reasoning structures including evidential relationships (SUPPORTS, REFUTES, CONTRADICTS), argumentative structure (HAS_PREMISE, HAS_CONCLUSION, HAS_WARRANT, JUSTIFIES, REBUTS, ASSUMES), scientific methodology (TESTS, PRODUCES, USES_METHOD, GENERATES), knowledge structure relationships (EXTENDS, SUPERSEDES, ANOMALOUS_TO, INSTANTIATES, DESCRIBES), model evaluation (EVALUATES, OUTPERFORMS, FAILS_ON), analogy and transfer (ANALOGOUS_TO, TRANSFERS_TO), reasoning chain operations (HAS_CHAIN_STEP, PROPAGATES_UNCERTAINTY_TO, SENSITIVE_TO, ROBUST_ACROSS), formal relationships (PROVEN_BY, DERIVED_FROM, RELIES_ON), and general epistemic relationships (ADDRESSES).

The remaining 46 named edge types are organized by functional category:
Structural edges (6): EXTRACTED_FROM (provenance from extracted node to source chunk, with optional location, method, and confidence properties), CHUNK_OF (chunk to parent document), PART_OF (generic compositional membership), HAS_PART (inverse compositional membership), INSTANCE_OF (type instantiation), and CONTAINS (parent to child containment).
Provenance edges (5): PROPOSED_BY (attribution of proposals to agents), AUTHORED_BY (document authorship), CITED_BY (citation relationships), BELIEVED_BY (epistemic attribution of beliefs to agents), and CONSENSUS_IN (community consensus attribution).
Intent edges (10): DECOMPOSES_INTO (goal decomposition into sub-goals or tasks), MOTIVATED_BY (motivation relationship from goal to rationale), HAS_OPTION (decision to available option), DECIDED_ON (decision to selected option), DECIDED_BY (decision attribution to a deciding agent or entity), CONSTRAINED_BY (goal or decision to constraint), BLOCKS (blocking relationship between tasks or goals), INFORMS (information flow from one decision to another), RELEVANT_TO (relevance relationship), and DEPENDS_ON (dependency between goals, tasks, or milestones).
Action edges (5): AVAILABLE_ON (affordance availability on a target), COMPOSED_OF (flow composition from flow steps), STEP_USES (flow step to affordance or resource usage), RISK_ASSESSED_BY (target to risk assessment), and CONTROLS (control mechanism to controlled entity).
Memory edges (5): CAPTURED_IN (entity to session capture), TRACE_ENTRY (session to trace record), SUMMARIZES (summary to summarized content), RECALLS (recall relationship from session to prior content), and GOVERNED_BY (entity to governing memory policy).
Agent edges (10): ASSIGNED_TO (task to assigned agent), PLANNED_BY (plan attribution to planning agent), HAS_STEP (plan to plan step), TARGETS (task to target node), REQUIRES_APPROVAL (action to approval requirement), EXECUTED_BY (execution attribution to agent), EXECUTION_OF (execution to source plan or task), PRODUCES_NODE (execution to produced graph node), GOVERNED_BY_POLICY (agent to governing policy), and BUDGET_FOR (safety budget to budgeted operation).
Temporal edges (1): FOLLOWS (temporal ordering between events or steps).
Social edges (4): WORKS_FOR (employment relationship), AFFILIATED_WITH (organizational affiliation), ABOUT (topical relationship from content to subject entity), and KNOWN_BY (familiarity relationship from entity to knowing agent).

### II.D. Probabilistic Knowledge Representation via Node-level Confidence and Salience

A distinguishing architectural feature of the present invention is the treatment of all knowledge as probabilistic rather than binary. In conventional knowledge graphs, the presence of a node or edge implicitly asserts truth: if a fact node exists, the fact is treated as true. The present invention departs from this convention by assigning every node in the knowledge graph two numerical metadata scores that characterize the epistemic status and contextual importance of the knowledge the node represents.

Confidence Score. Each node carries a confidence score field storing a floating-point value between 0.0 and 1.0 inclusive. The confidence score represents the assessed probability that the knowledge represented by the node is true. A confidence of 1.0 indicates a verified fact or direct first-hand observation. A confidence of 0.85 indicates information reported by a credible source. A confidence of 0.70 indicates plausible but unverified information. A confidence of 0.50 indicates uncertain or contested information. A confidence of 0.30 or below indicates speculative information. The default confidence for a newly created node (absent explicit assignment) is 1.0, reflecting maximum truth likelihood in the absence of contrary evidence. The confidence score is implemented as a validated newtype (referred to as Confidence in the preferred embodiment) that rejects values outside the 0.0 to 1.0 range at construction time, producing a structured error (InvalidConfidence) if the validation fails.

Salience Score. Each node carries a salience score field storing a floating-point value between 0.0 and 1.0 inclusive. The salience score represents the assessed contextual importance of the knowledge the node represents. A salience of 1.0 indicates a main topic or central finding. A salience of 0.7 indicates a significant supporting detail. A salience of 0.5 indicates knowledge that is mentioned but not central. A salience of 0.3 indicates a minor background detail. The default salience for a newly created node is 0.5, representing moderate contextual importance. The salience score is implemented as a validated newtype (referred to as Salience in the preferred embodiment) that rejects values outside the 0.0 to 1.0 range at construction time, producing a structured error (InvalidSalience) if the validation fails.

Architectural Separation from Discriminated Union Properties. A critical design decision is that the confidence score and salience score are node-level metadata fields that exist alongside but outside of the discriminated union property structure described in Section II.C. That is, the node data structure comprises: a unique identifier (uid), a node type, a cognitive layer assignment, a label, a summary, timestamps (created_at, updated_at), a version counter, the confidence score, the salience score, a privacy level, an optional embedding reference, tombstone fields, and the discriminated union property field. This separation means that every node in the knowledge graph regardless of whether it is an Entity, Claim, Hypothesis, Goal, Task, or any other of the 55 node types—carries assessed truth likelihood and assessed importance. The confidence and salience scores are orthogonal to the type-specific property structures: a Claim node's ClaimProps may include a certainty_degree field (reflecting the original author's certainty), while the node-level confidence score reflects the system's assessed probability that the claim is true based on all available evidence.

Storage as Database Columns. Because the confidence and salience scores are node-level metadata rather than embedded within the JSON-serialized discriminated union properties, they are stored as dedicated floating-point columns in the node database relation. This enables direct database queries that filter or sort nodes by confidence or salience without deserializing the JSON properties column. For example, the storage engine provides a query method (query_nodes_by_type_below_confidence in the preferred embodiment) that accepts a node type and a confidence threshold and returns all live (non-tombstoned) nodes of that type with confidence below the threshold, sorted by confidence in ascending order. This query is used by the integration system (Section V) to identify weakly-evidenced claims for targeted evidence gathering.

Exponential Salience Decay. The system implements an exponential salience decay function (decay_salience in the preferred embodiment) that models the natural decrease in relevance of knowledge over time. When invoked with a configurable half-life parameter (in seconds), the function: (a) reads all live nodes with their current salience and last-updated timestamp; (b) for each node, computes the elapsed time since the last update; (c) computes a decay factor as 0.5 raised to the power of (elapsed time/half-life); (d) multiplies the current salience by the decay factor to produce a decayed salience, clamped to the 0.0-1.0 range; (e) writes the decayed salience back to the storage engine for nodes where the change exceeds a minimum threshold (1e−9 in the preferred embodiment); and (f) returns the count of nodes decayed and the count of nodes that fell below a low-salience threshold (0.1). This decay function enables temporal prioritization of knowledge: recently updated or freshly extracted knowledge maintains its salience, while older knowledge gradually becomes less salient, without affecting confidence scores (which reflect truth likelihood, not recency).

Role in the Extraction Pipeline. During extraction (Section III), the language model assigns confidence and salience values to each extracted node based on confidence calibration scales and salience scoring guidance included in each cognitive-layer-specific extraction prompt. The confidence calibration scales map descriptive levels to numerical ranges: CERTAIN (0.95-1.0) for verified facts, HIGH (0.80-0.94) for credibly sourced information, MODERATE (0.50-0.79) for plausible but unverified information, UNCERTAIN (0.30-0.49) for contested information, and LOW (below 0.30) for speculative information. The salience scoring guidance instructs the language model to rate each extracted node's importance to the source text on the 0.0-1.0 scale. When the language model omits confidence or salience for a node, defaults of 0.8 (confidence) and 0.5 (salience) are applied during parsing (Step 530).

Role in the Integration System. The confidence and salience scores drive multiple aspects of the integration system (Section V). In claim selection (Section V.B), the system uses confidence to identify weakly-evidenced claims (Tier 2: confidence below 0.5) and salience to identify high-importance claims needing evidence (Tier 4: salience above 0.7 with confidence below 0.7). In verification (Section V.E), the confidence calibration axis assesses whether proposed confidence values are appropriate given the evidence landscape. In confidence cap enforcement (Section V.F), the system programmatically limits confidence based on evidence status classification and computes dynamic confidence ceilings based on the evidence landscape (supporting evidence count, average support strength, refutation count, and contradiction presence). These interactions create a closed-loop system in which confidence and salience are assigned during extraction, used to prioritize integration targets, and updated through verified integration proposals.

### II.E. Storage Engine Architecture

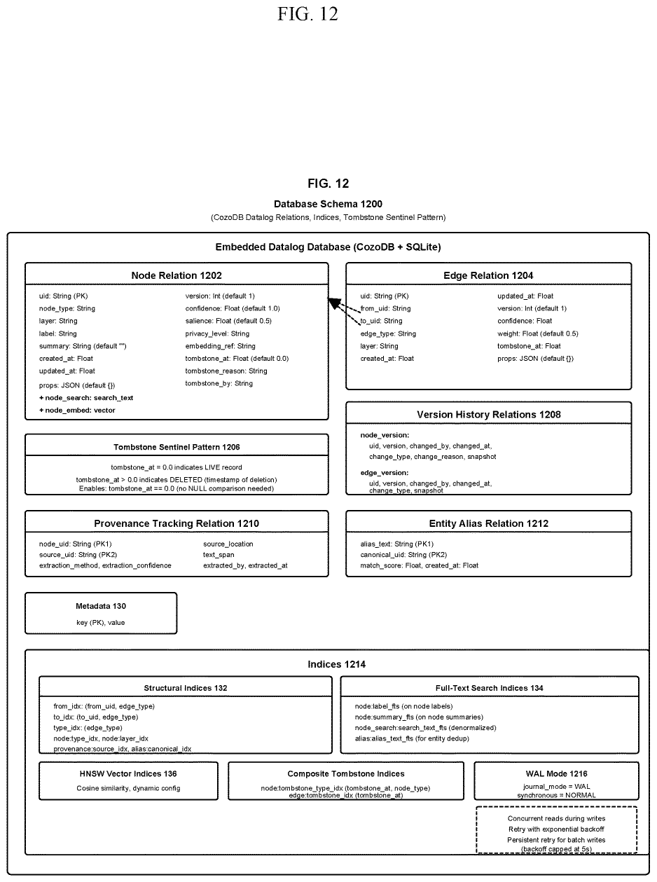

Referring now to FIG. 12, a diagram illustrating the database schema 1200 according to an embodiment of the present invention is shown. The node relation 1202 (shown in detail in FIG. 12) corresponds to the node relation 120 shown at a higher level of abstraction in FIG. 1. Similarly, edge relation 1204 corresponds to edge relation 122, version history relations 1208 correspond to version history relations 124, provenance tracking relation 1210 corresponds to provenance tracking relation 126, and entity alias relation 1212 corresponds to entity alias relation 128.

The storage engine 108 uses an embedded Datalog database engine (CozoDB) with a SQLite backend. The choice of Datalog as the query language provides native support for recursive graph traversal, pattern matching, and declarative join operations that are well-suited to knowledge graph workloads.

Node Relation 1202. The node relation stores the core node data with the following columns: uid (String, primary key), node_type (String), layer (String), label (String), summary (String, default empty), created_at (Float, seconds since epoch), updated_at (Float), version (Integer, default 1), confidence (Float, default 1.0), salience (Float, default 0.5), privacy_level (String, default “private”), embedding_ref (String, default empty), tombstone_at (Float, default 0.0), tombstone_reason (String, default empty), tombstone_by (String, default empty), and props (JSON, default empty object).

Edge Relation 1204. The edge relation stores edges with: uid (String, primary key), from_uid (String), to_uid (String), edge_type (String), layer (String), created_at (Float), updated_at (Float), version (Integer, default 1), confidence (Float, default 1.0), weight (Float, default 0.5), tombstone_at (Float, default 0.0), and props (JSON, default empty object).

Tombstone Sentinel Pattern 1206. Rather than using NULL values for the tombstone_at column (which Datalog engines may handle inconsistently in comparisons), the system uses a sentinel value of 0.0 (zero) to indicate a live (non-tombstoned) record. A tombstoned record has tombstone_at set to the actual deletion timestamp (a positive floating-point value). This sentinel pattern enables reliable filtering in Datalog queries using simple equality comparisons (tombstone_at==0.0) rather than NULL-checking predicates. A composite index on (tombstone_at, node_type) enables the database engine to skip tombstoned rows early in query processing rather than post-filtering after primary index scans, providing a measurable performance improvement at scale.

Version History Relations 1208. Append-only node_version and edge_version relations store complete snapshots of every node and edge modification, recording the changed_by agent, changed_at timestamp, change_type (e.g., “create”, “update”, “tombstone”), and change_reason. This provides full audit trails and enables temporal queries.

Provenance Tracking Relation 1210. The provenance relation stores extraction provenance with a compound primary key of (node_uid, source_uid), along with extraction_method, extraction_confidence, source_location, text_span, extracted_by, and extracted_at fields. This enables tracing any extracted node back to its source document and chunk.

Entity Alias Relation 1212. The alias relation stores entity name aliases with a compound primary key of (alias_text, canonical_uid) and additional match_score and created_at fields. This relation supports the multi-tier deduplication system by maintaining a mapping from variant entity names to canonical entity UIDs.

Indices 1214. The storage engine maintains multiple index types:
Structural indices: from_idx on (from_uid, edge_type), to_idx on (to_uid, edge_type), type_idx on (edge_type), node: type_idx on (node_type), node: layer_idx on (layer), provenance: source_idx on (source_uid), alias: canonical_idx on (canonical_uid).
Full-text search indices: node: label_fts on node labels, node:summary_fts on node summaries, node_search:search_text_fts on the denormalized search text extracted from node properties, and alias:alias_text_fts on the alias table for efficient entity deduplication.
HNSW vector indices: Configured dynamically when an embedding provider is set up, enabling approximate nearest-neighbor semantic similarity search across node embeddings.
Composite tombstone indices: node:tombstone_type_idx on (tombstone_at, node_type) and edge:tombstone_idx on (tombstone_at), enabling the database engine to efficiently filter tombstoned records.

WAL Mode and Concurrency 1216. Before the Datalog engine opens the SQLite file, the system explicitly sets the journal mode to Write-Ahead Logging (WAL) and the synchronous mode to NORMAL. WAL mode persists in the file header and is inherited by all subsequent connections. This configuration allows concurrent reads during writes, dramatically reducing lock contention in the multi-pass extraction pipeline where multiple parallel passes may issue read queries while other passes write results. The system also implements automatic retry with exponential backoff for transient “database is locked” errors, with a persistent retry variant for batch writes that retries indefinitely (with backoff capped at 5 seconds) since all data is buffered in memory and there is no reason to abandon a write due to lock contention alone.

### III. Multi-Pass Cognitive Layer Extraction Pipeline

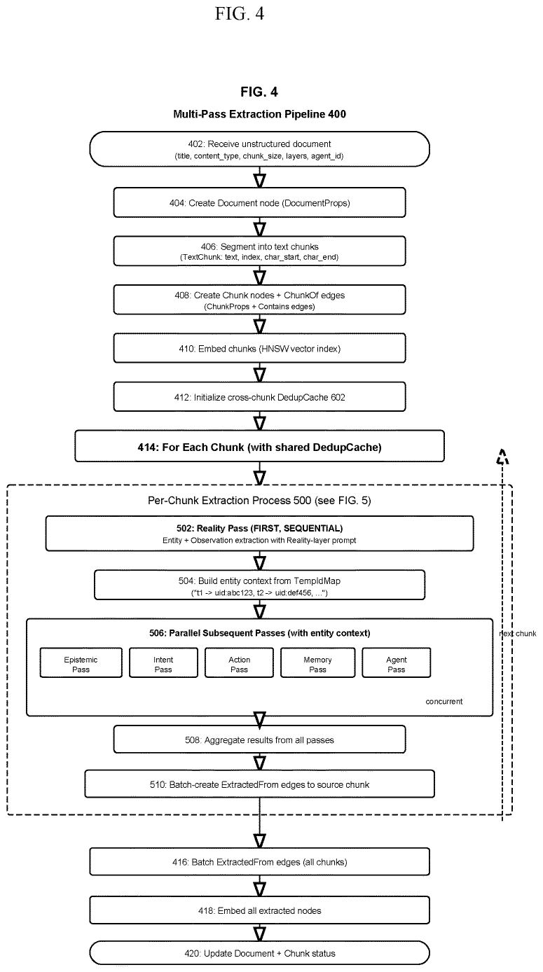

Referring now to FIGS. 4, 5, and 6, flowcharts and diagrams illustrating the multi-pass extraction pipeline 400 according to an embodiment of the present invention are shown.

### III.A. Pipeline Overview

The multi-pass extraction pipeline 400 is the system's method for converting unstructured text documents into structured knowledge graph content organized according to the cognitive layer architecture 200. Unlike prior art single-pass extraction approaches that attempt to extract all entity and relationship types in a single language model invocation, the pipeline 400 employs an ordered multi-pass architecture in which a first pass establishes an entity backbone and subsequent passes execute in parallel with layer-specific prompts.

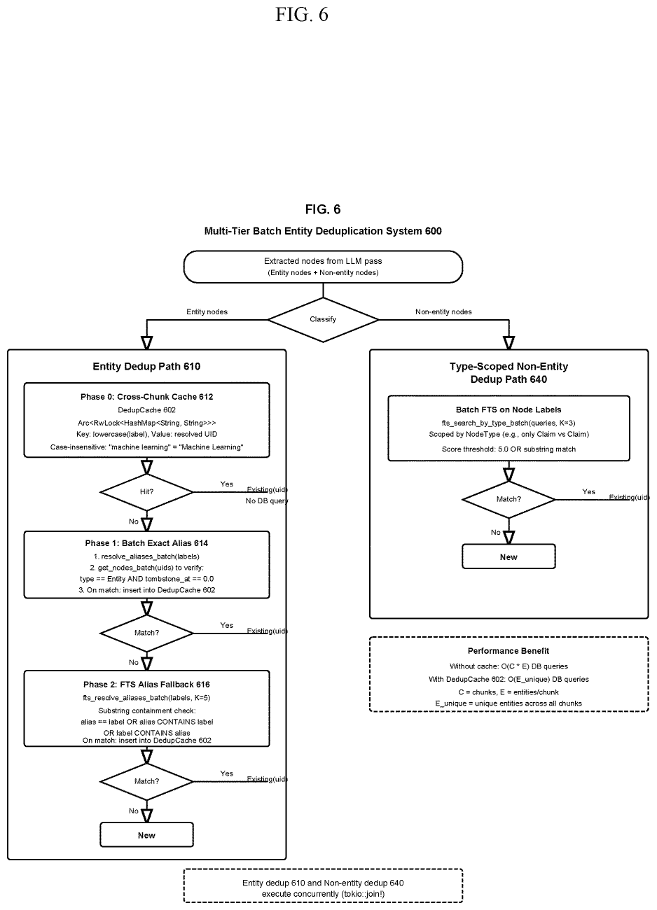

Referring to FIG. 4, the pipeline 400 proceeds as follows:
Step 402: Receive an unstructured text document and optional configuration parameters including title, document_type, content_type, source_uri, chunk_size, chunk_overlap, layers (a set of cognitive layers to extract), and agent_id.
Step 404: Create a Document node in the knowledge graph with typed DocumentProps properties.
Step 406: Segment the document into a plurality of text chunks using the text chunking module (described in Section III.B below), producing a set of TextChunk objects each containing a text string, a sequential index, and byte offset positions snapped to character boundaries.
Step 408: For each chunk, create a Chunk node in the knowledge graph with typed ChunkProps properties (including content, chunk_type, chunk_index, char_offset_start, char_offset_end, token_count_estimate, and processing_status), and create a ChunkOf edge from the Chunk node to the Document node and a Contains edge from the Document node to the Chunk node.
Step 410: Embed each chunk using the configured embedding provider, storing the resulting vector in the HNSW vector index for subsequent semantic similarity search.
Step 412: Initialize a cross-chunk deduplication cache (DedupCache 602 in FIG. 6) that will be shared across all chunks of this document.
Step 414: For each chunk, execute the per-chunk extraction process 500 (described in Section III.C below) with the shared dedup cache.
Step 416: After all chunks are processed, batch-create ExtractedFrom edges linking each extracted node back to its source chunk.
Step 418: Embed all newly created extracted nodes for semantic similarity search.
Step 420: Update the Document and Chunk processing status fields to reflect completion or failure.

### III.B. Text Chunking Module

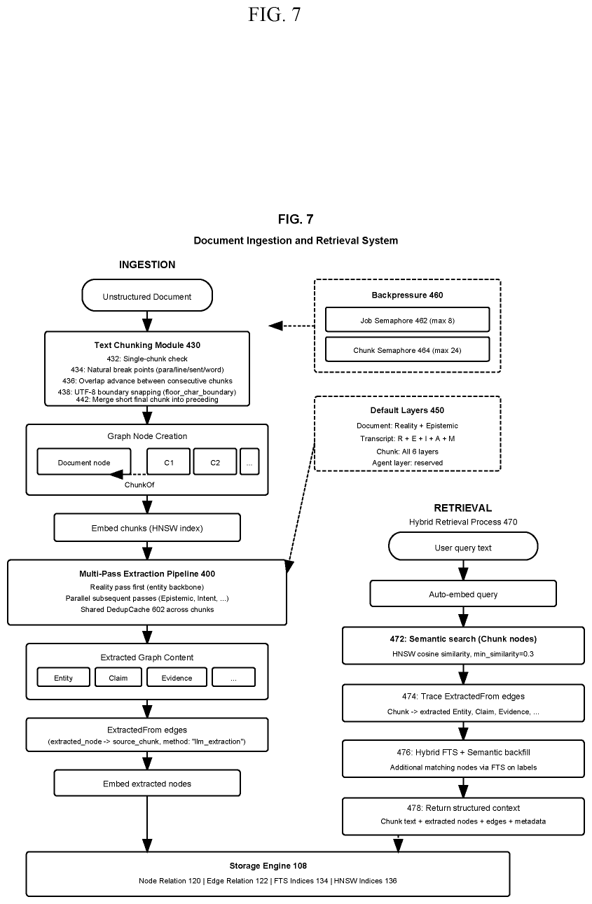

Referring now to FIG. 7, the text chunking module 430 implements a configurable text segmentation algorithm. The module 430 accepts a text string and a ChunkConfig configuration comprising: max_chunk_tokens (the maximum number of estimated tokens per chunk, default 2000, with tokens estimated as character count divided by 4), overlap_fraction (the fraction of max_chunk_tokens to overlap between consecutive chunks, default 0.10), and min_chunk_tokens (the minimum token count for a chunk to be kept as a standalone unit, default 100).

The chunking algorithm proceeds as follows:
Step 432: If the text fits within a single chunk (text length in bytes is less than or equal to max_chunk_tokens multiplied by 4), return the entire text as a single chunk.
Step 434: Otherwise, iterate through the text, attempting to find natural break points within each maximum-size window. The algorithm searches for break points in priority order: paragraph boundary (“\n\n”), line boundary (“\n”), sentence boundary (“.”, “?”, “!”), and word boundary (“ ”). For each window, the algorithm searches the second half of the window for the last occurrence of the highest-priority break point found. This produces chunks that align with natural text boundaries rather than cutting mid-sentence.
Step 436: After identifying a break point, advance the start position by the chunk size minus the overlap size, ensuring that consecutive chunks share a configurable amount of overlapping text. This overlap provides context continuity for the language model extraction passes.
Step 438: All byte offsets are snapped to valid UTF-8 character boundaries using a floor_char_boundary function that scans backwards from a target byte offset until a valid character boundary is found. This ensures that multi-byte UTF-8 characters (such as em-dashes, smart quotes, and non-Latin scripts) are never split mid-character.
Step 442: If the final chunk has fewer tokens than min_chunk_tokens, it is merged with the preceding chunk rather than being kept as an undersized standalone chunk.

Each resulting TextChunk carries a sequential index, the chunk text, and byte offset positions (char_start and char_end, named for historical compatibility but storing byte offsets snapped to Unicode character boundaries) into the original document, enabling precise provenance tracking.

### III.C. Per-Chunk Extraction Process

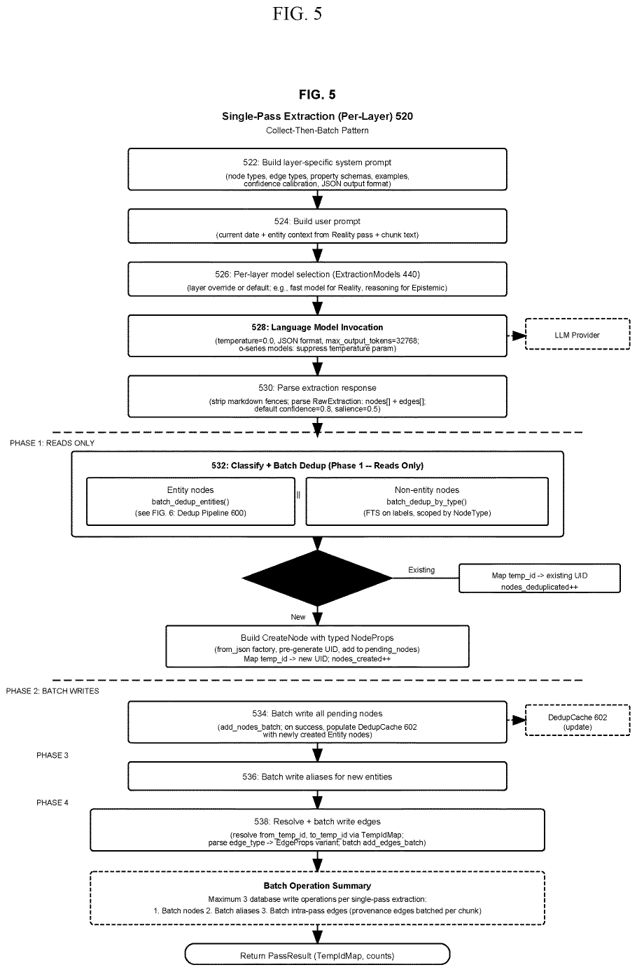

Referring to FIG. 5, the per-chunk extraction process 500 for a single chunk across specified cognitive layers proceeds as follows:
Step 502: Reality Pass (First, Sequential). If the Reality layer is among the specified layers, execute a single-pass extraction 520 (described in Section III.D below) for the Reality layer. This pass uses the Reality layer-specific prompt to extract Entity and Observation nodes. The Reality pass produces a temporary ID map (TempIdMap) that maps each temporary extraction ID (assigned by the language model, e.g., “t1”, “t2”) to the actual graph UID of the corresponding node (either newly created or resolved through deduplication). The Reality pass always executes first because it establishes the entity backbone that subsequent passes reference.
Step 504: Build Entity Context. After the Reality pass completes, build an entity context string from the temporary ID map. This string lists each temporary ID and its resolved graph UID (e.g., “t1->uid:abc123”). This entity context is passed to all subsequent extraction passes, enabling them to reference entities identified in the Reality pass by their temporary IDs rather than requiring each subsequent pass to independently re-identify the same entities.
Step 506: Parallel Subsequent Passes. Spawn asynchronous tasks for each remaining specified cognitive layer (Epistemic, Intent, Action, Memory, Agent). Each task executes a single-pass extraction 520 with the entity context from step 504 appended to the user prompt. These tasks execute concurrently using the asynchronous runtime (in the preferred embodiment, Tokio). The parallel execution of subsequent passes provides a significant latency improvement: whereas sequential execution of N passes requires time proportional to N multiplied by the per-pass latency, parallel execution requires time proportional to the maximum per-pass latency (plus the fixed Reality pass latency), since the remaining passes run concurrently.
Step 508: Aggregate Results. Wait for all parallel tasks to complete. Aggregate the results, including counts of nodes created, nodes deduplicated, edges created, extracted node UIDs, and any errors.
Step 510: Batch ExtractedFrom Edges. Batch-create ExtractedFrom edges from all extracted nodes to the source chunk node, with edge properties recording the extraction method as “llm_extraction”. These edges are created in a single batch write operation to minimize database round-trips.

### III.D. Single-Pass Extraction (Per-layer)

Each single-pass extraction 520 follows a collect-then-batch pattern designed to minimize database write operations:
Step 522: Build Layer-Specific Prompt. Select the system prompt for the target cognitive layer using the system_prompt_for_layer function. Each layer has a dedicated system prompt containing: (a) the complete list of valid node types for that layer with all required and optional properties, their types, and valid values; (b) the complete list of valid edge types for that layer with their properties; (c) output format specification requiring a JSON object with “nodes” and “edges” arrays; (d) multiple detailed examples showing correct extraction for that layer's node types; and (e) extraction guidelines including confidence calibration scales, salience scoring guidance, and layer-specific instructions.

In the preferred embodiment, the Reality layer prompt instructs extraction of Entity and Observation nodes with specific property schemas; the Epistemic layer prompt instructs extraction of all 24 epistemic node types organized into subcategories (core reasoning, knowledge structures, scientific methodology, formal structures, patterns and comparisons, reasoning meta-structures, and questions) with 31 epistemic edge types; the Intent layer prompt instructs extraction of Goal, Project, Decision, Constraint, and Milestone nodes with specific guidance on user vs. third-party attribution (Goals and Projects are extracted only for the document author, while Decisions may be attributed to third parties via DECIDED_BY edges); the Action layer prompt instructs extraction of Affordance and RiskAssessment nodes; the Memory layer prompt instructs extraction of Preference and Summary nodes; and the Agent layer prompt instructs extraction of Task and Plan nodes.
Step 524: Build User Prompt. Construct the user prompt by concatenating: the current date (for temporal reference resolution), any entity context from the Reality pass, and the chunk text.
Step 526: Per-Layer Model Selection. Select the language model for this layer using the ExtractionModels configuration. The system supports per-layer model overrides configured via environment variables (MINDGRAPH_LLM_MODEL_REALITY, MINDGRAPH_LLM_MODEL_EPISTEMIC, etc.), enabling the use of fast, inexpensive models for entity extraction (Reality layer) and more capable reasoning models for epistemic analysis (Epistemic layer). If no layer-specific override is configured, the default model is used. Unlike prior art approaches that employ separate language models for extraction and classification (e.g., one model to identify entities and a second model to classify them), the present invention uses a single language model invocation per layer pass, with the layer-specific prompt combining extraction and classification into a single operation.
Step 528: Language Model Invocation. Send the system prompt and user prompt to the configured language model chat provider with temperature set to 0.0 (deterministic output), maximum output tokens set to 32,768 tokens, and JSON response format requested. The system detects whether the model is a reasoning-series model (by checking if the model name starts with “o”) and suppresses the temperature parameter for such models, as they do not support it.
Step 530: Parse Extraction Response. Parse the language model's JSON response into a RawExtraction structure containing arrays of RawNode objects (with temp_id, label, summary, confidence, salience, and props fields) and RawEdge objects (with from_temp_id, to_temp_id, edge_type, and props fields). The parser handles common language model output variations including markdown code fences around JSON output. Default values are provided for confidence (0.8) and salience (0.5) when the language model omits these fields.
Step 532: Classify and Batch Dedup (Phase 1—Reads Only). Classify each extracted node as either an Entity node or a non-entity node based on the _type field in its properties. For Entity nodes, extract the label and entity_type. For non-entity nodes, compose a dedup text by concatenating the label and summary. Then, execute entity deduplication and non-entity deduplication concurrently using the multi-tier batch deduplication system (described in Section III.E below). This concurrent execution (using tokio::join! in the preferred embodiment) ensures that both dedup paths execute in parallel.

For each node, the dedup result is either Existing(uid), meaning an existing node in the graph was matched and should be reused, or New, meaning no match was found and a new node should be created.

For nodes with a New dedup result, construct a CreateNode object with the parsed NodeProps (deserialized from JSON using the type-directed factory method described in Section II.C), assign a pre-generated UID, and collect the node in a pending_nodes buffer. Populate the temporary ID map with the mapping from the LLM's temp_id to the assigned UID. For nodes with an Existing dedup result, populate the temporary ID map with the mapping from the LLM's temp_id to the existing UID and increment the nodes_deduplicated counter.
Step 534: Batch Write Nodes (Phase 2). Write all pending new nodes to the database in a single batch operation using the add_nodes_batch API. If the batch write succeeds, populate the cross-chunk dedup cache with any newly created Entity nodes. If the batch write fails (e.g., due to persistent database lock contention), remove the failed nodes from the temporary ID map.
Step 536: Batch Write Aliases (Phase 3). For each newly created Entity node, create an alias entry mapping the entity label to the entity UID with a match score of 1.0. Write all aliases in a single batch operation.
Step 538: Resolve and Batch Write Edges (Phase 4). For each edge in the language model's output, resolve the from_temp_id and to_temp_id through the temporary ID map to obtain actual graph UIDs. If both UIDs resolve successfully, construct a CreateEdge object with the appropriate EdgeProps variant (determined by parsing the edge_type string). Write all resolved edges in a single batch operation.

The collect-then-batch pattern (steps 532-538) ensures that each single-pass extraction performs at most three database write operations (nodes, aliases, intra-pass edges) regardless of the number of nodes and edges extracted. Provenance edges (ExtractedFrom) for all passes are batch-created once per chunk in the outer per-chunk extraction process (step 510). This represents a significant reduction in database I/O compared to approaches that write each node and edge individually.

### III.E. Multi-Tier Batch Entity Deduplication

Referring now to FIG. 6, the multi-tier batch entity deduplication system 600 according to an embodiment of the present invention is shown.

The deduplication system 600 resolves extracted entities against existing knowledge graph content and against entities extracted from earlier chunks of the same document. It comprises two parallel dedup paths: an entity dedup path 610 for Entity nodes and a type-scoped dedup path 640 for non-entity nodes.

### Entity Dedup Path 610:

Phase 0—Cross-Chunk Cache Lookup 612: For each entity, check the DedupCache 602. The DedupCache 602 is an in-memory hash map protected by an asynchronous read-write lock (Arc<RwLock<HashMap<String, String>>>), shared across all chunks of the same document. The cache maps lowercased entity labels to resolved UIDs. If a cache hit is found, the entity is immediately resolved without any database query. This phase eliminates redundant database queries when the same entity appears in multiple chunks of the same document, reducing database queries from O(C * E) to O(E_unique) where C is the number of chunks, E is the average entities per chunk, and E_unique is the number of unique entities across all chunks. The case-insensitive lookup (via lowercasing) ensures that variant capitalizations (e.g., “machine learning” vs. “Machine Learning”) resolve to the same cached entry.

Phase 1—Batch Exact Alias Resolution 614: For entities not found in the cache, collect all unresolved labels and perform a single batch alias resolution query against the alias relation. This returns a list of canonical UIDs for entities that have exact alias matches. Then, perform a batch node verification query that fetches the matched nodes and verifies that each is a live Entity node (not tombstoned, correct type). Successfully verified matches are inserted into the DedupCache 602 and returned as Existing dedup results.

Phase 2—FTS Alias Fallback 616: For entities still unresolved after exact alias matching, perform a batch full-text search on the alias table. For each unresolved entity, the FTS query returns the top K matches (K=5 in the preferred embodiment) ranked by FTS score. The system then applies a substring containment check: if the lowercased alias text matches the lowercased search label exactly, contains the search label, or is contained by the search label, the match is accepted. This handles common alias variations such as “OpenAI” matching “OpenAI, Inc.” or “GPT-4” matching “OpenAI GPT-4”. Successfully matched entities are inserted into the DedupCache 602 and returned as Existing dedup results. Entities that remain unresolved after this phase are returned as New dedup results.

### Type-Scoped Non-Entity Dedup Path 640:

For non-entity nodes (e.g., Claim, Hypothesis, Pattern), the system performs batch full-text search on node labels scoped by node type. The FTS search pre-filters results with a minimum score threshold (0.8 in the preferred embodiment) before returning results. For each non-entity node, the system searches for existing nodes of the same type with similar labels, returning the top 3 matches that exceed the minimum score. A match is then accepted if the FTS score exceeds a higher acceptance threshold (5.0 in the preferred embodiment) or if the lowercased label matches via substring containment. This type-scoped dedup ensures that, for example, a Claim node about “climate change impacts” is only compared against other Claim nodes, not against Entity nodes or Hypothesis nodes that might share similar labels.

Both dedup paths execute concurrently (via tokio::join!) to minimize dedup latency.

### III.F. Per-Layer Model Configuration

The extraction pipeline supports per-layer model configuration through the ExtractionModels structure 440. This structure contains a default model name and optional per-layer overrides for each of the six cognitive layers. The overrides are populated from environment variables (MINDGRAPH_LLM_MODEL_REALITY, MINDGRAPH_LLM_MODEL_EPISTEMIC, etc.). A model_for method returns the configured model for a given layer, falling back to the default if no layer-specific override is set.

This configuration enables deployment strategies such as: using a fast, inexpensive model (e.g., a 4-billion parameter model) for Reality layer entity extraction where the task is relatively straightforward, while using a more capable reasoning model (e.g., a frontier-class model with chain-of-thought capabilities) for Epistemic layer analysis where formal argumentation structures require deeper reasoning.

### III.G. Content-Type-Aware Default Layer Selection

The extraction pipeline implements content-type-aware default layer selection 450. When the caller does not explicitly specify which cognitive layers to extract, the system selects default layers based on the document's content_type:

Documents: Default layers vary by content_type. The system implements content-type-aware defaults that tailor extraction to the expected cognitive content of each document type:
(a) “article” (the default content_type, also used for “paper” and “book”): Reality+Epistemic (2 passes). This default reflects the observation that most written documents primarily contain factual entities and epistemic content (claims, evidence, arguments).
(b) “meeting_notes”: Reality+Epistemic+Intent+Action (4 passes). Meeting notes typically contain discussed entities, epistemic claims, goals and decisions, and action items.
(c) “journal”: Reality+Epistemic+Intent+Memory (4 passes). Journal entries contain factual references, epistemic reflections, personal goals and decisions, and preferences and summaries.
(d) “report”: Reality+Epistemic+Intent+Action (4 passes). Reports contain factual entities, epistemic analysis, strategic goals and decisions, and procedural content.

Transcripts (session transcripts): Default to Reality+Epistemic+Intent+Action+Memory (5 passes). Transcripts often contain goals, decisions, action items, and personal reflections in addition to factual and epistemic content.

Chunks (standalone text segments): Default to Reality+Epistemic+Memory (3 passes). When processing isolated text chunks, the system extracts key factual entities, epistemic content (claims, evidence, arguments), and experiential content (preferences, summaries). The Intent, Action, and Agent layers are managed agentically rather than inferred from ingested content.

The Agent layer is reserved for agentic interaction patterns and is not included in automatic document extraction defaults.

### III.H. Ingestion Backpressure System

Also shown in FIG. 7, the server module 104 implements an ingestion backpressure system 460 to prevent resource exhaustion during heavy ingestion workloads. The system uses two counting semaphores (in the preferred embodiment, Tokio Semaphore instances stored in an IngestionSemaphores struct):

A global job semaphore 462 (default capacity 8, configurable via MINDGRAPH_MAX_INGESTION_JOBS environment variable) that limits the number of concurrent document/session ingestion jobs.

A global chunk semaphore 464 (default capacity 24, configurable via MINDGRAPH_MAX_INGESTION_CHUNKS environment variable) that limits the number of concurrent chunk extraction tasks across all jobs.

When a new document ingestion job is submitted, the background task attempts to acquire a permit from the job semaphore. If no permit is available, the job remains in a “Pending” state. Polling the job status endpoint returns the job's current queue_position. The permit acquisition is interruptible via a cancellation token (implemented using tokio::select!), enabling jobs to be cancelled while waiting in the queue. This backpressure mechanism prevents unbounded memory growth and API rate limit exhaustion.

### III.I. Fault-Tolerant Extraction Resume

The server module 104 further implements automatic extraction resume for fault tolerance. When a document processing job is interrupted (e.g., by a server restart or transient failure), the system detects incomplete chunks via their processing_status field. On server startup, an auto-resume function scans for Document nodes with processing_status in “processing” or “pending” states, finds their incomplete chunks via CONTAINS edge traversal, and automatically spawns resume background tasks for each interrupted document. A manual resume endpoint (POST/ngest/resume/{document_uid}) allows targeted re-extraction of failed chunks without re-chunking the document, since chunk nodes already exist in the graph with their content. After resuming, the system re-evaluates overall document status by checking the processing_status of all associated chunks, not just the resumed ones.

### III.J. Worked Example

To illustrate the operation of the extraction pipeline 400, consider the ingestion of a scientific article about climate change adaptation strategies.

The document (approximately 8,000 words) is chunked into 5 text chunks of approximately 1,600 words each with 10% overlap.

For Chunk 1, the Reality pass extracts entities such as “IPCC” (Entity, entity_type: “organization”), “Paris Agreement” (Entity, entity_type: “event”), and “global temperature rise of 1.5C” (Observation, observation_type: “measurement”). The temporary ID map now contains: t1->uid:ipcc001, t2->uid:paris001, t3->uid:temp001.

The Epistemic pass (running in parallel with other remaining passes) receives the entity context and extracts: “Climate adaptation is more cost-effective than mitigation alone” (Claim, claim_type: “causal”), “Meta-analysis of 47 studies” (Evidence, evidence_type: “statistical”, sample_size: 47), and a SUPPORTS edge from the Evidence to the Claim.

For Chunk 2, the Reality pass encounters “IPCC” again. The DedupCache 602 contains the entry “ipcc”->“uid:ipcc001” from Chunk 1, so the entity is resolved instantly without any database query. This cache hit eliminates the alias resolution and FTS queries that would otherwise be required.

After all 5 chunks are processed, each extracted node has an ExtractedFrom edge linking it back to its source chunk, each chunk has a ChunkOf edge to the document, and all entities are deduplicated across chunks.

### III.K. Hybrid Retrieval Process

Also shown in FIG. 7, the system implements a hybrid retrieval process 470 for retrieving structured context from the knowledge graph in response to user queries. The retrieval process 470 proceeds as follows:
Step 472: Semantic Search on Chunk Nodes. The system auto-embeds the user query text using the configured embedding provider and performs an approximate nearest-neighbor search on Chunk node embeddings using the HNSW vector indices 136, with a minimum similarity threshold (0.3 in the preferred embodiment). This step retrieves the chunks most semantically relevant to the query.
Step 474: ExtractedFrom Edge Traversal. For each retrieved Chunk node, the system traces ExtractedFrom edges to identify all nodes that were extracted from those chunks, including Entity, Claim, Evidence, and other typed nodes. This traversal recovers the structured knowledge derived from the relevant source text.
Step 476: Hybrid FTS and Semantic Backfill. The system performs additional full-text search and semantic search on node labels and summaries to discover matching nodes that may not be linked via provenance to the initially retrieved chunks. This backfill step ensures broad coverage, capturing relevant nodes that were extracted from chunks not returned in the initial semantic search.
Step 478: Structured Context Response. The system assembles and returns the structured context comprising: the text content of relevant chunks, the extracted nodes with their full typed properties, the edges connecting those nodes, and metadata including similarity scores and provenance information.

The retrieval process 470 enables retrieval-augmented generation (RAG) workflows in which an AI assistant can ground its responses in both the original source text (via chunk content) and the structured knowledge graph (via extracted nodes and edges with typed properties).

### IV. Cognitive Endpoints with Deep-Merge Property Override

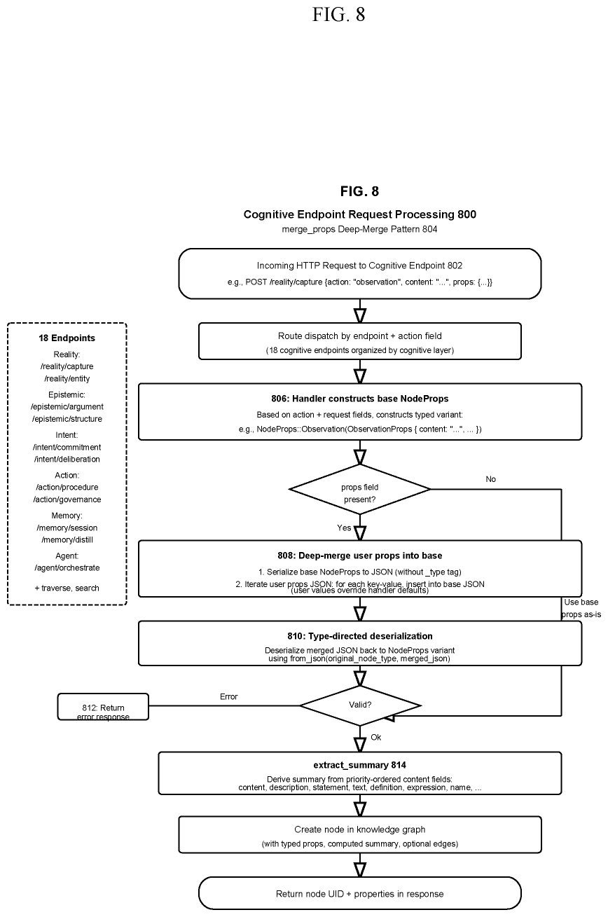

Referring now to FIG. 8, a diagram illustrating the cognitive endpoint request processing flow 800 according to an embodiment of the present invention is shown.

### IV.A. Endpoint Architecture

The server module 104 exposes 18 cognitive endpoints 802 that map high-level semantic operations to typed graph primitives. Unlike generic CRUD endpoints that operate directly on nodes and edges, cognitive endpoints accept semantically meaningful request parameters and internally construct the appropriate typed node properties, create the node, and establish any necessary edges.

The 18 cognitive endpoints are organized by cognitive layer:
Reality Layer (2 endpoints): /reality/capture (actions: source, snippet, observation), /reality/entity (entity creation and management with built-in deduplication).
Epistemic Layer (3 endpoints): /epistemic/argument (monolithic argument construction creating Claim, Evidence, Warrant, and Argument nodes with HAS_PREMISE, HAS_CONCLUSION, HAS_WARRANT, and SUPPORTS edges in a single request), /epistemic/inquiry (actions: hypothesis, theory, paradigm, anomaly, assumption, question, open_question), /epistemic/structure (actions for concept, method, experiment, model, model_evaluation, pattern, analogy, mechanism, inference_chain, sensitivity_analysis, reasoning_strategy, theorem, and equation).
Intent Layer (2 endpoints): /intent/commitment (actions: goal, project, milestone), /intent/deliberation (actions: open_decision, decide, add_option, add_constraint).
Action Layer (2 endpoints): /action/procedure (actions: add_affordance, add_flow, add_flow_step, add_control), /action/risk (actions: assess, get_assessments).
Memory Layer (3 endpoints): /memory/session (actions: open, add_trace, close, journal), /memory/distill (monolithic distillation creating Summary, Preference, and MemoryPolicy nodes), /memory/config (actions: set_preference, set_policy, get_preferences, get_policies).
Agent Layer (3 endpoints): /agent/plan (actions: create_task, create_plan, add_step, update_status, get_plan), /agent/governance (actions: create_policy, set_budget, request_approval), /agent/execution (actions: start, complete).
Additional cross-layer endpoints (3 endpoints): /retrieve (actions: text, semantic, layer for search and retrieval across the graph), /traverse (actions: chain, neighborhood, path for graph traversal), /evolve (actions: update, tombstone, restore, decay for node lifecycle management).
   IV.B. The merge_props Deep-Merge Pattern

A key innovation of the cognitive endpoint architecture is the merge_props deep-merge pattern 804. This pattern enables callers to override any property of a node type while still benefiting from the semantic defaults constructed by the endpoint handler.

### The Merge_props Function 804 Operates As Follows:

Step 806: The endpoint handler constructs a base NodeProps variant from the request parameters. For example, the /reality/capture endpoint with action “observation” constructs a NodeProps::Observation(ObservationProps::default( )).
Step 808: If the request includes a “props” field containing a JSON object, the function serializes the base NodeProps to JSON (without the type tag) and deep-merges the user's JSON values by iterating over the user object's key-value pairs and inserting each into the base JSON object. User values override base values.
Step 810: The merged JSON is deserialized back into the correct NodeProps variant using the type-directed factory method, with the node type determined from the original base props.
Step 812: If deserialization fails (e.g., because the user provided an invalid value for a typed field), the function returns a structured error response identifying the problematic field.

This pattern provides three technical advantages: (a) callers receive sensible defaults for all properties without needing to specify them; (b) callers can override any property including those not exposed as top-level request parameters, giving full control over the node's typed properties; (c) the type-directed deserialization ensures that the overridden values conform to the property type's schema, maintaining type safety.

### IV.C. Summary Extraction

Each cognitive endpoint implements an extract_summary function 814 that derives a human-readable summary string from the constructed node properties when the caller does not explicitly provide a summary. The function examines a priority-ordered list of content-bearing fields (content, description, statement, text, definition, expression, name, title, principle, canonical_name, question, focus_summary) and returns the first non-empty value found. This ensures that every node has a meaningful summary for display and search purposes without requiring callers to redundantly specify summary text.

### V. Agentic Cross-Document Integration

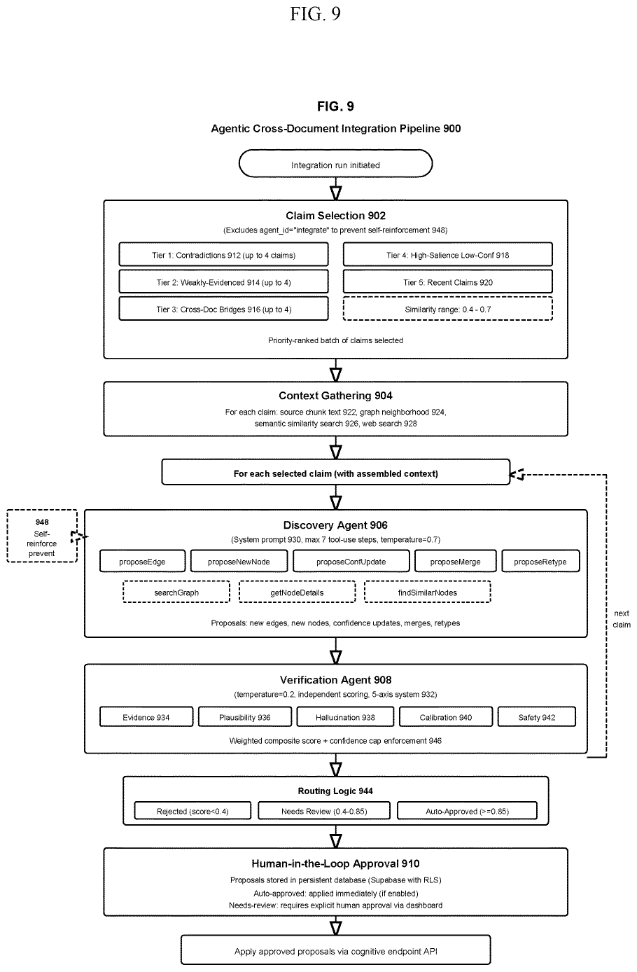

Referring now to FIGS. 9, 10, and 11, flowcharts and diagrams illustrating the agentic cross-document integration system 900 according to an embodiment of the present invention are shown.

### V.A. Integration Pipeline Overview

Referring to FIG. 9, the integration pipeline 900 provides a computer-implemented method for discovering and verifying cross-document knowledge connections in the knowledge graph. The pipeline 900 comprises five phases: claim selection 902, context gathering 904, discovery 906, verification 908, and human-in-the-loop approval 910.

The pipeline 900 addresses a fundamental challenge in multi-document knowledge management: as documents are ingested independently, the knowledge graph accumulates islands of information that may contain contradictions, complementary evidence, hidden assumptions, or opportunities for synthesis that are not captured by the per-document extraction pipeline. The integration pipeline 900 employs a dual-agent architecture to discover and validate these cross-document connections.

### V.B. Claim Selection Algorithm

The claim selection phase 902 selects a batch of claims from the knowledge graph for analysis, applying a priority ranking designed to maximize the value of each integration run. The selection algorithm proceeds through the following priority tiers:
Tier 1—Contradictions 912 (highest priority, up to 4 claims). The system queries for existing contradiction edges in the graph and batch-fetches the nodes on both sides of each contradiction. Claims involved in contradictions are the highest-priority targets because resolving contradictions directly improves knowledge graph consistency.
Tier 2—Weakly-Evidenced Claims 914 (up to 4 claims). The system queries for claims with confidence below a threshold (0.5 in the preferred embodiment). These claims have the most to gain from additional evidence gathering.
Tier 3—Cross-Document Bridge Candidates 916 (up to 4 claims). For remaining candidate claims, the system performs semantic similarity search to find claims from other documents that address similar topics but with a moderate similarity score (between 0.4 and 0.7). This range targets claims that are related but not identical, representing the highest-value opportunities for cross-document synthesis.
Tier 4—High-Salience Low-Confidence Claims 918 (fill remaining slots). Claims with high salience (above 0.7) but low confidence (below 0.7) are important topics that lack strong evidence.
Tier 5—Recent Claims 920 (fill remaining slots). The most recently created claims fill any remaining slots, biasing toward fresh content.

Each priority tier is implemented as a specific database query pattern against the knowledge graph's indices: Tier 1 executes contradiction edge traversal using the edge type index, Tier 2 performs confidence-threshold filtering using the node table's confidence column, Tier 3 uses vector similarity scoring via the HNSW index with bounded similarity range filtering, Tier 4 combines salience and confidence column filters, and Tier 5 applies temporal ordering using the created_at timestamp index. The selection algorithm excludes claims created by the integration agent itself (identified by agent_id stored within the node's props JSON field, with value “integrate”) to prevent self-reinforcing feedback loops. It also excludes claims processed in prior integration runs, tracked by storing claim UIDs in the integration_runs database table.

### V.C. Context Gathering

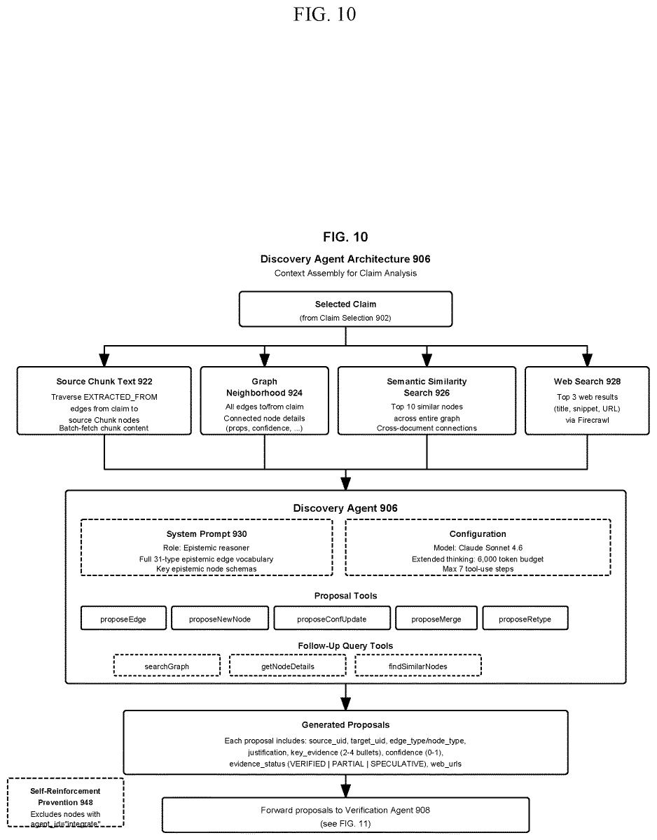

Referring to FIG. 10, the context gathering phase 904 assembles rich contextual information for each selected claim, comprising four data sources:
Source Chunk Text 922. The system traverses EXTRACTED_FROM edges from the claim to its source Chunk nodes, then batch-fetches the chunk content. This provides the original text context from which the claim was extracted, enabling the discovery agent to ground its analysis in the source material.
Graph Neighborhood 924. The system fetches all edges to and from the claim, then batch-fetches all connected node details including their full typed properties (e.g., content, description, statement, principle for epistemic nodes). The neighborhood context is formatted as a structured list showing edge direction, edge type, connected node label, type, UID, confidence, summary, and key property values. Document and Chunk nodes are excluded from the neighborhood display to avoid cluttering the context.
Semantic Similarity Search 926. The system performs a semantic similarity search using the claim's summary text, returning the top 10 most similar nodes across the entire graph. These results represent potential cross-document connections that share semantic content with the claim. The discovery agent is specifically instructed to examine these similar nodes for contradictions (claims addressing the same topic with opposite conclusions).
Web Search Results 928. When configured with a web search provider (in the preferred embodiment, Firecrawl), the system searches the web using the claim label and returns the top 3 results with titles, snippets, and URLs. Web results provide external evidence that may support, refute, or contextualize the claim.

### V.D. Discovery Agent

The discovery agent 906 is an AI agent (in the preferred embodiment, Claude Sonnet 4.6 with extended thinking enabled and a 6,000-token thinking budget) equipped with a set of proposal tools and follow-up query tools.

### Proposal Tools:

proposeEdge: Proposes a new edge between two existing nodes, requiring source_uid, target_uid, human-readable labels for both nodes, edge_type (from the full epistemic edge vocabulary), justification, key_evidence (2-4 bullet points of specific evidence), confidence (0-1), evidence_status (VERIFIED, PARTIAL, or SPECULATIVE), and optional web_urls.

proposeNewNode: Proposes creating a new node with specified node_type, label, summary, confidence, typed properties, a list of edges to create to/from existing nodes (each with target_uid, target_label, edge_type, and direction), justification, key_evidence, evidence_status, and optional web_urls.

proposeConfidenceUpdate: Proposes updating the confidence of an existing node based on the evidence landscape, requiring node_uid, current_confidence, proposed_confidence, supporting_evidence_count, avg_support_strength, refuting_evidence_count, has_contradictions, and justification. This tool applies a programmatic confidence ceiling formula (described in Section V.F below) to cap the proposed confidence.

proposeMerge: Proposes merging two entities that refer to the same real-world thing, requiring keep_uid, merge_uid, and justification.

proposeRetype: Proposes changing the type of an existing node, requiring node_uid, current_type, proposed_type, and justification.

### Follow-Up Query Tools:

searchGraph: Searches the knowledge graph with a text query.

getNodeDetails: Retrieves full details about a specific node.

findSimilarNodes: Finds nodes semantically similar to given text.

The discovery agent's system prompt 930 is a comprehensive instruction set that defines its role as an epistemic reasoner, lists all valid node types and the full 31-type epistemic edge vocabulary, provides detailed schemas for key epistemic node types (Evidence, Warrant, Argument, Hypothesis, Analogy, Assumption, Pattern, Question, Method, Experiment), establishes guidelines emphasizing cross-document synthesis, contradiction detection, epistemic scaffolding, and calibrated confidence, and provides examples of high-quality versus weak proposals.

The agent is limited to a maximum of 7 tool-use steps to prevent excessive computation.

### V.E. Verification Agent

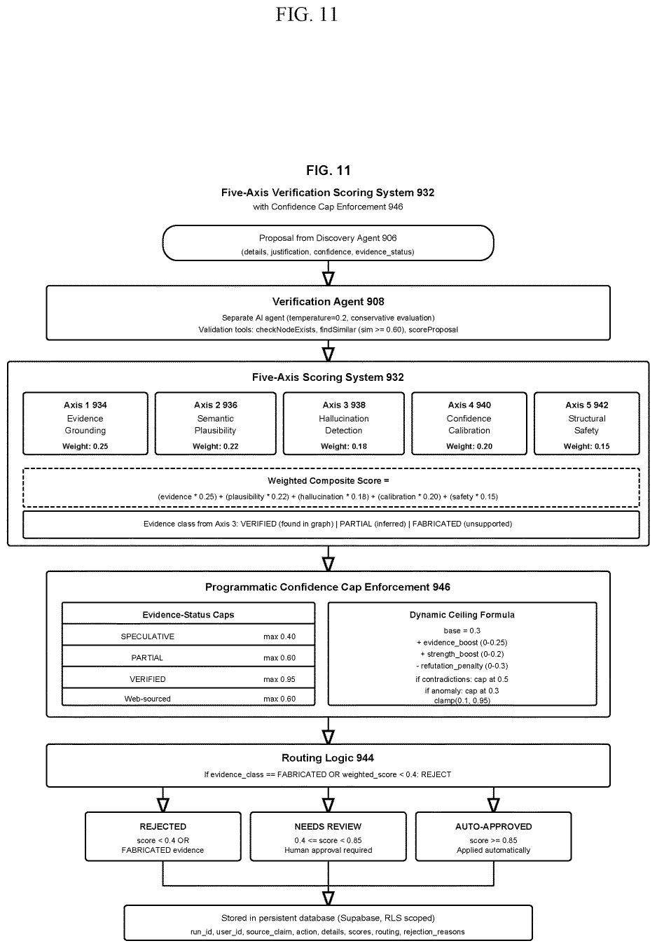

Referring to FIG. 11, the verification agent 908 is a separate AI agent that independently evaluates each proposal from the discovery agent. The verification agent receives the proposal details, justification, proposed confidence, and evidence status, and uses validation tools to check the proposal's quality.

### Validation Tools:

checkNodeExists: Verifies that a referenced node exists in the graph and returns its details.

findSimilar: Checks semantic similarity between text and existing nodes, used to verify that proposed connections are semantically meaningful (requiring similarity>=0.60).

scoreProposal: Submits the final verification score, requiring scores on five axes.

### Five-Axis Scoring System 932:

The verification agent scores each proposal on five independent quality axes, each weighted according to its importance:
Axis 1—Evidence Grounding (weight 0.25) 934: Are the referenced nodes real and does actual evidence support the proposal?
Axis 2—Semantic Plausibility (weight 0.22) 936: Does the proposal make semantic sense as verified by embedding similarity?
Axis 3—Hallucination Detection (weight 0.18) 938: Is the information VERIFIED (found in graph), PARTIAL (inferred from graph context), or FABRICATED (not supported by any evidence)?
Axis 4—Confidence Calibration (weight 0.20) 940: Is the proposed confidence appropriate given the evidence landscape?
Axis 5—Structural Safety (weight 0.15) 942: Would the proposal create orphan nodes, duplicate entities, type mismatches, or other structural problems?

The weighted composite score is computed as:
weighted_score=(evidence_grounding 0.25)+(semantic_plausibility 0.22)+(hallucination_detection 0.18)+(confidence_calibration 0.20)+(structural_safety*0.15)

### Routing Logic 944:

Based on the composite score and evidence classification, each proposal is routed to one of three categories:
Rejected: If the evidence class is FABRICATED or the weighted score is below 0.4.
Auto-Approved: If the weighted score is at or above 0.85.
Needs Review: All other proposals (weighted score between 0.4 and 0.85).

The verification agent uses a lower temperature (0.2) than the discovery agent (0.7) to produce more conservative and consistent evaluations.

### V.F. Programmatic Confidence Cap Enforcement

The confidence caps are enforced at two levels. First, the verification agent's system prompt instructs it to apply these caps during scoring, guiding the agent to evaluate confidence calibration with awareness that automatic capping will occur. Second, after the verification agent produces its score, the system applies programmatic confidence cap enforcement 946 that overrides the proposed confidence based on evidence status, ensuring compliance regardless of agent behavior:
SPECULATIVE evidence status: Maximum confidence capped at 0.40.
PARTIAL evidence status: Maximum confidence capped at 0.60.
VERIFIED evidence status: Maximum confidence capped at 0.95.

If the evidence class from verification is FABRICATED, the maximum confidence is set to 0.40 regardless of the originally declared evidence status.

Additionally, the verification agent's system prompt instructs it to limit confidence for proposals based primarily on web-sourced evidence to no greater than 0.60. This prompt-based guidance operates as a complementary mechanism to the programmatic caps described above, providing defense-in-depth confidence calibration.

Additionally, the proposeConfidenceUpdate tool applies a dynamic confidence ceiling formula that considers the full evidence landscape:
base=0.3
evidence_boost=0.25 if supporting_count>=5, else 0.15 if >=3, else 0.10 if >=1, else 0
strength_boost=0.1*avg_support_strength+(0.1 if avg_support_strength>0.7 else 0)
refutation_penalty=0.1*min(3, refuting_count)
max_confidence=base+evidence_boost+strength_boost−refutation_penalty
if has_contradictions: max_confidence=min(max_confidence, 0.5)
if has_anomaly: max_confidence=min(max_confidence, 0.3)
max_confidence=clamp(max_confidence, 0.1, 0.95)

This formula ensures that confidence values are grounded in the actual evidence landscape rather than being set arbitrarily by the discovery agent. The formula's key properties are: (a) base confidence is low (0.3) and must be earned through evidence; (b) more supporting evidence and stronger support increase the ceiling, but with diminishing returns; (c) refuting evidence and contradictions actively reduce the ceiling; (d) the has_anomaly parameter is reserved for future use and defaults to false in the preferred embodiment (only the has_contradictions parameter is populated from the discovery agent's input); when enabled, the presence of anomalies would set a hard ceiling of 0.3.

When a proposed confidence exceeds the computed maximum, the system silently adjusts it downward and records the adjustment in the proposal's process_quality metadata (including the original proposed value and the capped value), rather than rejecting the proposal outright.

### V.G. Human-in-the-Loop Approval

The human-in-the-loop phase 910 stores all proposals in a persistent database (in the preferred embodiment, Supabase with row-level security scoped to the user). Each proposal record includes: the run identifier, user identifier, source claim UID and label, action type, structured details, justification, proposed confidence, evidence status, web evidence, verification score, axis scores, process quality metadata, routing decision, and rejection reasons.

Proposals routed as “auto_approved” may be applied to the knowledge graph without human intervention if the user has enabled automatic application. Proposals routed as “needs_review” require explicit human approval through the dashboard interface. Proposals routed as “rejected” are stored for transparency but are not applied.

When a user approves a proposal, the apply endpoint executes the proposed graph modification (creating edges, creating nodes, updating confidence values, or merging entities) through the standard cognitive endpoint API, ensuring that all type validation, deduplication, and provenance tracking mechanisms are applied to the approved modifications.

### V.H. Self-Reinforcement Prevention

The integration system implements self-reinforcement prevention 948 to avoid the discovery agent building upon its own prior proposals in a feedback loop. Specifically:
(a) The claim selection algorithm excludes any node with agent_id “integrate” (the agent identifier used by the integration system).
(b) The discovery agent's system prompt explicitly instructs it not to propose connections to nodes created by agent_id “integrate”.
(c) Previously processed claim UIDs are tracked across integration runs and excluded from future selection.

### V.I. Cost Tracking

Both the discovery and verification agents return token usage information (input tokens and output tokens). The integration system accumulates cost estimates per run using the formula:
cost_cents=(input_tokens/1,000,000)*input_price_per_million+(output_tokens/1,000,000)*output_price_per_million

This cost data is recorded per integration run in the database for usage tracking and billing purposes.

### VI. Alternative Embodiments

### VI.A. Alternative Storage Engines

While the preferred embodiment uses CozoDB with a SQLite backend as the storage engine, the cognitive layer architecture and multi-pass extraction pipeline are not limited to this specific storage technology. In alternative embodiments, the storage engine may be replaced with: (a) a graph database such as Neo4j or Amazon Neptune, with the Datalog queries translated to Cypher or SPARQL; (b) a relational database such as PostgreSQL with JSON column support; (c) a distributed key-value store such as Apache Cassandra or ScyllaDB for horizontal scalability; or (d) an in-memory database for low-latency applications. The discriminated union property type system and cognitive layer mapping function are independent of the storage engine and may be implemented in any programming language that supports algebraic data types or tagged unions.

### VI.B. Alternative Language Model Providers

While the preferred embodiment uses OpenAI's API for language model invocations during extraction, the system defines abstract traits (ChatProvider and AsyncChatProvider) that may be implemented for any language model provider including Anthropic, Google, open-source models hosted locally, or specialized domain-specific models. The per-layer model configuration enables using different providers for different layers (e.g., a local open-source model for Reality extraction and a cloud-hosted frontier model for Epistemic analysis).

### VI.C. Alternative Cognitive Layer Configurations

While the preferred embodiment defines six cognitive layers with 55 node types, the cognitive layer architecture is extensible. Additional cognitive layers may be defined (e.g., a Social layer for representing social relationships and influence, a Temporal layer for explicit temporal reasoning, or a Spatial layer for geographic and spatial reasoning). The Custom node type mechanism allows user-defined node types to be assigned to any existing cognitive layer, and new layers may be added by extending the Layer enumeration.

### VI.D. Alternative Deduplication Strategies

While the preferred embodiment uses a multi-tier deduplication system with exact alias matching and FTS fallback, alternative deduplication strategies may be employed including: (a) embedding-based similarity using cosine similarity between node embeddings; (b) MinHash or Locality-Sensitive Hashing for approximate matching at scale; (c) learned entity resolution models fine-tuned on domain-specific data; or (d) graph-structure-based deduplication that considers the neighborhood topology in addition to label similarity.

### VI.E. Alternative Verification Architectures

While the preferred embodiment uses a single verification agent with five scoring axes, alternative verification architectures may employ: (a) multiple specialized verification agents, each focused on a different quality axis; (b) ensemble verification with majority voting across multiple agent instances; (c) human expert verification for high-stakes domains; or (d) probabilistic verification using calibrated language model confidence scores.

### VI.F. Multi-Tenant Deployment

In a multi-tenant deployment embodiment, the system provides a tenant graph pool that lazily loads and caches per-tenant knowledge graph instances. Each tenant (organization) receives an isolated knowledge graph stored in a separate database file. The pool implements per-organization mutex locks to prevent concurrent database opens (a SQLite limitation), and uses reference counting to prevent eviction of graphs with active background tasks (e.g., ongoing extraction jobs). Rate limiting, usage tracking, and authentication are provided through an axum middleware stack comprising CORS, authentication (JWT or API key), graph resolution, and usage tracking layers applied in sequence.

### VII. Technical Improvements Over Prior Art

The present invention provides the following specific technical improvements over prior art knowledge graph systems:
Reduced Extraction Latency. The parallel execution of cognitive layer extraction passes (Section III.C) reduces total extraction time compared to sequential processing. For a document processed with N cognitive layers, the total extraction time is approximately T_reality+max(T_epistemic, T_intent, T_action, T_memory, T_agent) rather than T_reality+T_epistemic+T_intent+T_action+T_memory+T_agent. In practice, this represents a latency reduction of approximately 40-60% for full six-layer extraction.

Reduced Database Queries. The cross-chunk deduplication cache (Section III.E, Phase 0) eliminates redundant database queries for entities that appear in multiple chunks of the same document. For a 10-chunk document with an entity appearing in 8 of the 10 chunks, the cache reduces the number of database queries for that entity from 8 (one per chunk) to 1 (the first occurrence), a reduction of 87.5%.

Compile-Time Type Safety. The discriminated union property type system (Section II.C) provides compile-time guarantees that are absent in schemaless property graph systems. Pattern matching exhaustiveness checking ensures that all code paths handle all 55 node type variants, eliminating an entire class of runtime errors.

Improved Knowledge Quality. The dual-agent verification system (Section V.E) with programmatic confidence caps (Section V.F) prevents overconfident knowledge assertions by bounding confidence values based on empirical evidence counts and verification scores. The five-axis scoring system provides multi-dimensional quality assessment that a single confidence score cannot capture.

Probabilistic Knowledge Representation. Unlike prior art knowledge graphs that treat knowledge as binary (present equals true), the present invention assigns every node a confidence score (probability of truth) and a salience score (contextual importance) as node-level metadata fields stored alongside but outside of the type-specific property structure (Section II.D). This architectural separation enables: (a) direct database queries that filter or sort by confidence or salience without deserializing JSON properties; (b) extraction-time calibration via language-model-guided confidence and salience assignment using per-layer calibration scales; (c) integration-time prioritization via multi-tier claim selection that targets contradictions, weakly-evidenced claims, and high-salience low-confidence claims; (d) evidence-grounded confidence updates via the dynamic confidence ceiling formula that computes maximum allowed confidence from the evidence landscape; and (e) temporal relevance management via exponential salience decay that automatically reduces the salience of older knowledge relative to more recently updated knowledge without altering truth assessments.

Batch Operation Efficiency. The collect-then-batch pattern (Section III.D) ensures that each single-pass extraction performs at most three database write operations (nodes, aliases, intra-pass edges) regardless of the number of extracted nodes and edges, with provenance edges batched once per chunk across all passes. This represents a significant reduction in I/O overhead compared to per-node write approaches.

Content-Aware Extraction. The content-type-aware default layer selection (Section III.G) optimizes extraction cost by selecting only the relevant cognitive layers for each document type, avoiding unnecessary language model invocations for layers unlikely to yield useful content.

What is claimed is:

1. A computer-implemented method for extracting structured knowledge from an unstructured text document into a knowledge graph organized according to a cognitive layer architecture, the method comprising: receiving, by a processor, the unstructured text document; segmenting, by the processor, the unstructured text document into a plurality of text chunks; for each text chunk, processing the text chunk through a trained language model configured with one or more cognitive-layer-specific extraction prompts, the cognitive layer architecture comprising a plurality of predefined cognitive layers including at least a reality cognitive layer representing ground-truth observations about the world and an epistemic cognitive layer representing knowledge structures and reasoning, wherein each cognitive-layer-specific extraction prompt specifies a complete extraction schema for a respective cognitive layer, the complete extraction schema comprising a set of valid node types assigned to that cognitive layer, a set of valid edge types for that cognitive layer, type-specific property structures defining required and optional fields for each node type, and extraction guidelines including confidence calibration scales mapping descriptive certainty levels to numerical ranges and salience scoring guidance, wherein the trained language model assigns to each extracted node a confidence score representing a probability of truth and a salience score representing contextual importance based on the confidence calibration scales and salience scoring guidance; for each node extracted by the trained language model, constructing a typed node having a node type deterministically assigned to exactly one cognitive layer by a layer assignment function, a discriminated union property structure containing type-specific fields corresponding to that node type, and the confidence score and salience score assigned by the trained language model stored as node-level metadata fields alongside but outside of the discriminated union property structure; resolving each extracted node against existing nodes in the knowledge graph to identify duplicate entities; and storing the extracted nodes and edges with their associated cognitive layer assignments, discriminated union property structures, confidence scores, and salience scores in an embedded database, and creating provenance edges linking each extracted node to its source text chunk.

2. The method of claim 1, wherein the plurality of predefined cognitive layers further comprises an intent cognitive layer representing goals and decisions, an action cognitive layer representing capabilities and procedures, a memory cognitive layer representing experiential records, and an agent cognitive layer representing agent operations, and wherein the layer assignment function deterministically maps each of a plurality of node types to exactly one of the six cognitive layers.

3. The method of claim 1, wherein the processing step comprises: executing a first extraction pass using a first cognitive-layer-specific extraction prompt for the reality cognitive layer to extract entity nodes and observational relationship edges forming an entity backbone, and generating a temporary identifier map that maps language-model-assigned temporary identifiers to resolved knowledge graph node identifiers; constructing an entity context data structure from the temporary identifier map; and executing one or more subsequent extraction passes for additional cognitive layers, each subsequent extraction pass receiving the entity context data structure enabling reference to entities identified in the first extraction pass by their temporary identifiers without re-identification.

4. The method of claim 3, wherein the one or more subsequent extraction passes are executed concurrently on the processor, each subsequent extraction pass processing the text chunk through the trained language model configured with a different cognitive-layer-specific extraction prompt, and wherein the first extraction pass for the reality cognitive layer completes before the one or more subsequent extraction passes begin, such that subsequent passes reference an established entity backbone.

5. The method of claim 1, further comprising, prior to the processing step, selecting a subset of the plurality of predefined cognitive layers based on a content type of the unstructured text document, wherein different content types map to different subsets of cognitive layers.

6. The method of claim 5, wherein when the content type indicates an article or paper, the subset comprises the reality cognitive layer and the epistemic cognitive layer; when the content type indicates meeting notes, the subset further comprises an intent cognitive layer and an action cognitive layer; and when the unstructured text document is a transcript of a conversational session, the subset comprises the reality cognitive layer, the epistemic cognitive layer, an intent cognitive layer, an action cognitive layer, and a memory cognitive layer.

7. The method of claim 1, further comprising selecting a language model for each cognitive layer using a per-layer model configuration, wherein the per-layer model configuration specifies a default language model and optional per-layer override language models, enabling use of a first language model optimized for entity extraction for the reality cognitive layer and a second language model optimized for reasoning for the epistemic cognitive layer.

8. The method of claim 1, wherein each cognitive-layer-specific extraction prompt for the epistemic cognitive layer specifies at least twenty node types organized into subcategories comprising core reasoning types including claim, evidence, warrant, argument, and assumption; knowledge structure types including concept, hypothesis, theory, paradigm, and anomaly; scientific methodology types including method and experiment; formal structure types including theorem, equation, model, and model evaluation; and at least thirty-one edge types enabling representation of evidential, argumentative, scientific, and formal reasoning relationships.

9. The method of claim 1, wherein each extraction pass follows a collect-then-batch pattern comprising: invoking the language model to produce a structured extraction response, performing entity resolution for all extracted nodes, batch-writing all new nodes in a single database write operation, batch-writing all entity aliases in a single database write operation, and batch-writing all resolved edges in a single database write operation, whereby each extraction pass performs a bounded number of database write operations regardless of the number of extracted nodes and edges.

10. The method of claim 1, further comprising creating provenance edges of a predetermined provenance edge type from each extracted node to the source text chunk from which it was extracted, and creating structural edges from each text chunk to its parent document node, thereby enabling traversal from any extracted node to its original source text via a two-hop path through the source text chunk and the parent document.

11. The method of claim 1, wherein the confidence calibration scales in each cognitive-layer-specific extraction prompt map descriptive certainty levels to numerical ranges comprising at least: a certain level mapped to a range of 0.95 to 1.0 for verified facts or direct first-hand observations, a high confidence level mapped to a range of 0.80 to 0.94 for information reported by credible sources, a moderate confidence level mapped to a range of 0.50 to 0.79 for plausible but unverified information, an uncertain level mapped to a range of 0.30 to 0.49 for contested or speculative information, and a low confidence level mapped to a range below 0.30 for highly uncertain information, wherein the salience scoring guidance instructs the trained language model to assign salience values on a scale from 0.0 to 1.0 based on centrality to the text with a value near 1.0 indicating a main topic, a value near 0.7 indicating a significant supporting detail, a value near 0.5 indicating a mentioned but non-central item, and a value near 0.3 indicating a minor background detail.

12. The method of claim 1, wherein when the trained language model omits a confidence score or a salience score for an extracted node, the method applies a default confidence value of 0.8 and a default salience value of 0.5, and wherein the confidence score and the salience score are each validated on construction to ensure the value falls within the range of 0.0 to 1.0 inclusive, with values outside the range producing a validation error.

13. A knowledge graph system comprising: a processor; a non-transitory computer-readable memory storing instructions that, when executed by the processor, cause the processor to maintain a knowledge graph in an embedded database engine, the knowledge graph organized according to a cognitive layer architecture, the system comprising: a schema module defining a plurality of cognitive layers, each cognitive layer corresponding to a different cognitive function, and a plurality of node types, each node type deterministically assigned to exactly one of the plurality of cognitive layers by a layer assignment function implemented as an exhaustive pattern match over the plurality of node types; a node data structure for each node in the knowledge graph, each node data structure comprising: a confidence score field storing a floating-point value between 0.0 and 1.0 inclusive representing a probability that the knowledge represented by the node is true, a salience score field storing a floating-point value between 0.0 and 1.0 inclusive representing contextual importance of the knowledge represented by the node, and a discriminated union property field, wherein the confidence score field and the salience score field are node-level metadata fields stored alongside but outside of the discriminated union property field such that every node in the knowledge graph carries assessed truth likelihood and assessed importance regardless of node type; a discriminated union property type for node properties stored in the discriminated union property field, the discriminated union property type comprising one variant for each node type of the plurality of node types, each variant wrapping a type-specific property structure defining fields specific to that node type, wherein the discriminated union property type is tagged by a discriminator field that identifies which variant is active, and wherein the exhaustive pattern match enforces at compile time that all code paths handle all variants of the discriminated union property type; a type-directed deserialization factory method that accepts a node type value and a serialized data value and produces the correctly typed variant of the discriminated union property type, enabling reconstruction of strongly-typed property structures from the embedded database without embedding type tags in every stored data record; a corresponding discriminated union property type for edge properties comprising one variant for each of a plurality of edge types; and a storage engine comprising the embedded database engine storing node data and edge data in respective database relations, the storage engine maintaining full-text search indices on node labels and properties and vector similarity indices for semantic search across node embeddings, the storage engine storing the confidence score field and the salience score field as columns in the node data relation enabling direct database queries that filter or sort nodes by confidence score or salience score without deserialization of the discriminated union property field.

14. The system of claim 13, wherein the plurality of cognitive layers comprises six cognitive layers: a reality cognitive layer for ground-truth observations, an epistemic cognitive layer for knowledge structures and formal reasoning, an intent cognitive layer for goals and decisions, an action cognitive layer for capabilities and procedures, a memory cognitive layer for experiential records, and an agent cognitive layer for agent operations in multi-agent systems.

15. The system of claim 14, wherein the epistemic cognitive layer comprises at least twenty-four node types organized into subcategories comprising: core reasoning types including claim, evidence, warrant, argument, and assumption; knowledge structure types including concept, hypothesis, theory, paradigm, and anomaly; scientific methodology types including method and experiment; formal structure types including theorem, equation, model, and model evaluation; pattern and comparison types including pattern, analogy, and mechanism; reasoning meta-structure types including inference chain, sensitivity analysis, and reasoning strategy; and question types including question and open question.

16. The system of claim 15, further comprising at least thirty-one epistemic edge types enabling representation of evidential relationships, argumentative structure, scientific methodology relationships, knowledge structure relationships, model evaluation relationships, analogy and transfer relationships, reasoning chain operations, and formal relationships.

17. The system of claim 13, wherein the storage engine employs a tombstone sentinel pattern for soft deletion in which a tombstone timestamp field uses a sentinel value of zero to indicate a live record and a positive floating-point timestamp value to indicate a deleted record, the storage engine maintaining a composite index on the tombstone timestamp field and node type field enabling early filtering of deleted records during query processing.

18. The system of claim 13, further comprising a server module exposing a plurality of cognitive endpoints via a network interface, each cognitive endpoint mapping a semantic operation to typed graph primitives, wherein each cognitive endpoint implements a deep-merge property override operation that: constructs a base instance of the discriminated union property type from request parameters, serializes the base instance to an intermediate data representation, merges user-provided property values into the intermediate data representation with user values overriding base values, and deserializes the merged intermediate data representation back into the correctly typed variant of the discriminated union property type using the type-directed deserialization factory method.

19. The system of claim 13, further comprising a searchable text extraction method implemented on the discriminated union property type that iterates over a predefined set of text-bearing field names across all variants and concatenates non-empty text values into a single searchable string stored in a denormalized search relation indexed with full-text search, enabling unified text search across all node types without per-type search logic.

20. The system of claim 13, further comprising an exponential salience decay function that, when invoked with a half-life parameter, computes for each live node in the knowledge graph a decay factor equal to 0.5 raised to the power of the elapsed time since the node was last updated divided by the half-life parameter, multiplies the node's current salience score by the decay factor to produce a decayed salience score, and writes the decayed salience score back to the storage engine, wherein the exponential salience decay function enables temporal prioritization of knowledge by automatically reducing the salience of older knowledge relative to more recently updated knowledge without altering confidence scores.

21. The system of claim 13, wherein the confidence score field and the salience score field are each implemented as validated newtypes that reject values outside the range of 0.0 to 1.0 inclusive at construction time, the confidence score field having a default value of 1.0 representing maximum truth likelihood in the absence of contrary evidence, and the salience score field having a default value of 0.5 representing moderate contextual importance, and wherein the storage engine provides a query method that accepts a node type and a confidence threshold and returns all live nodes of the specified type with confidence scores below the threshold sorted by confidence score in ascending order, enabling identification of weakly-evidenced knowledge for targeted evidence gathering.

22. A computer-implemented method for integrating knowledge across multiple documents in a knowledge graph in which each node carries a confidence score representing a probability of truth and a salience score representing contextual importance as node-level metadata fields, the method comprising: selecting, by a processor, a set of candidate claims from the knowledge graph based on a multi-tier priority ordering, the multi-tier priority ordering comprising: a first tier prioritizing claims involved in contradiction edges within the knowledge graph, a second tier prioritizing claims with confidence scores below a predetermined threshold, a third tier prioritizing claims for which a semantic similarity search identifies other claims from different source documents with similarity scores within a predetermined numerical range having a lower bound above a minimum similarity threshold indicating meaningful relatedness and an upper bound below a maximum similarity threshold indicating near-duplication thereby identifying cross-document bridge candidates, and a fourth tier prioritizing claims with salience scores above a first threshold and confidence scores below a second threshold, wherein the selecting step excludes claims previously created by the integration method itself to prevent self-reinforcing feedback loops; for each candidate claim, gathering a context data structure comprising: source text retrieved by traversing provenance edges from the candidate claim to source chunk nodes and extracting chunk content, graph neighborhood data comprising edges and connected nodes with their typed properties, semantically similar nodes identified via vector similarity search across the knowledge graph, and external evidence obtained via web search; processing the candidate claim and the context data structure through a first AI agent configured as a discovery agent, the discovery agent being equipped with a set of proposal tools comprising at least: a tool for proposing new edges between existing nodes, a tool for proposing new nodes with edges to existing nodes, a tool for proposing confidence score updates to existing nodes, and a tool for proposing merges of duplicate entities; processing each proposal generated by the discovery agent through a second AI agent configured as a verification agent, the verification agent scoring each proposal on a plurality of independent quality axes and producing a weighted composite score; applying, by the processor, programmatic confidence caps that override proposed confidence values based on evidence status classification, wherein the programmatic confidence caps enforce that a maximum confidence value for proposals classified as speculative is no greater than a first ceiling value, a maximum confidence value for proposals classified as partially evidenced is no greater than a second ceiling value higher than the first ceiling value, and a maximum confidence value for proposals with verified evidence is no greater than a third ceiling value higher than the second ceiling value, and wherein when the verification agent classifies the evidence as fabricated the first ceiling value is applied regardless of the originally declared evidence status classification; and routing each proposal to one of a plurality of disposition categories based on the weighted composite score and the evidence status classification, and storing each proposal in a persistent data store for human review prior to application to the knowledge graph.

23. The method of claim 22, wherein the plurality of independent quality axes comprises: an evidence grounding axis assessing whether referenced nodes exist and actual evidence supports the proposal, a semantic plausibility axis assessing whether the proposal makes semantic sense as verified by embedding similarity, a hallucination detection axis classifying the proposal information as verified, partial, or fabricated, a confidence calibration axis assessing whether the proposed confidence is appropriate given the evidence landscape, and a structural safety axis assessing whether the proposal would create orphan nodes, duplicate entities, or type mismatches.

24. The method of claim 22, wherein the routing step routes proposals to: a rejected category when the evidence classification is fabricated or the weighted composite score is below a rejection threshold; an auto-approved category when the weighted composite score is at or above an approval threshold; and a needs-review category for all other proposals.

25. The method of claim 22, wherein the tool for proposing confidence score updates to existing nodes applies a dynamic confidence ceiling formula that computes a maximum allowed confidence value based on an evidence landscape, the dynamic confidence ceiling formula comprising: a base value of 0.3; an evidence boost value that increases with the count of supporting evidence nodes according to a tiered schedule in which one or more supporting nodes yield a first boost, three or more supporting nodes yield a second boost larger than the first boost, and five or more supporting nodes yield a third boost larger than the second boost; a strength boost value computed as a function of the average support strength of the supporting evidence nodes; a refutation penalty value computed as a function of the count of refuting evidence nodes; a contradiction cap that limits the maximum allowed confidence to no more than 0.5 when contradicting claims exist in the knowledge graph; and a final clamping step that constrains the maximum allowed confidence to a range between 0.1 and 0.95 inclusive, whereby the proposed confidence value is capped at the computed maximum allowed confidence if the proposed value exceeds the maximum, and the adjustment is recorded in the proposal metadata without rejecting the proposal.
